(19) United States
(12) Patent Application Publication
(10) Pub. No.: US 2016/0078559 A1
(43) Pub. Date: Mar. 17, 2016

(54) SYSTEMS AND METHODS FOR HOUSEHOLD CASH MANAGEMENT SYSTEM

(71) Applicant: John Ventura, Weston, CT (US)

(72) Inventor: John Ventura, Weston, CT (US)

(21) Appl. No.: 14/743,617

(22) Filed: Jun. 18, 2015

Related U.S. Application Data
(63) Continuation of application No. 13/655,956, filed on Oct. 19, 2012, now abandoned.
(60) Provisional application No. 61/549,002, filed on Oct. 19, 2011.

(51) Int. Cl. G06Q 40/00

(52) U.S. Cl. CPC G06Q 40/12

(57) ABSTRACT

To address the challenges of managing the cash flow of a household, the present solution provides for an efficient and automated cash flow management tool. In an industrialized market where households incur and manage dozens of bills and expenses, the systems and methods of the Cash Flow Management system (“CFM”) of the present solution enables households to seamlessly and efficiently plan their budget, pay their bills, enforce their expense budget, save for custom planned goals and realize their financial plans all from one account. The methodology of the CFM allows a household to holistically plan, execute, manage and track in real-time their cash flow across pay, spend and save sub-accounts within the same financial or bank account.

### RELATED APPLICATION

This application claims the benefit of and priority to U.S. Provisional Application No. 61/549,002, entitled “Systems and Methods For Household Cash Management System” and filed on Oct. 19, 2011, which is incorporated herein by reference in its entirety for all purposes.

A portion of the disclosure of this patent document contains material which is subject to copyright protection. The copyright owner has no objection to the facsimile reproduction by anyone of the patent document or the patent disclosure, as it appears in the file or records of the Patent and Trademark Office, but otherwise reserves all copyright rights whatsoever.

### FIELD OF THE DISCLOSURE

This disclosure generally relates to systems and methods for managing cash flow in a household. In particular, this disclosure relates to systems and methods for planning a household's cash flow and then implementing, enforcing, monitoring, and updating the plan as needed.

### BACKGROUND OF THE DISCLOSURE

A typical household incurs a vast array of bills each month, while individual household members make numerous purchases on a weekly or daily basis. Households use separate systems to monitor their account balance, pay their bills, and make their purchases. To avoid having a negative account balance, households attempt to use yet another system to plan a budget. Relying on several separate systems makes it challenging for a household to plan, monitor, and enforce their cash flow.

### BRIEF SUMMARY OF THE DISCLOSURE

To address the challenges of managing the cash flow of a household, the present solution provides for an efficient and automated cash flow management tool. In an industrialized market where households incur and manage dozens of bills and expenses, the systems and methods of the Cash Flow Management system (“CFM”) of the present solution enables households to seamlessly and efficiently plan their budget, pay their bills, enforce their expense budget, save for custom planned goals and realize their financial plans all from one account. The methodology of the CFM allows a household to holistically plan, execute, manage and track in real-time their cash flow across pay, spend and save sub-accounts within the same financial or bank account.

A user can plan the deployment or use of their household cash flow across each of these sub-accounts of pay, spend and save. A user may configure the account to receive income from one or more sources, such as from direct deposit of a work check on a recurring basis. The user plans the allocation of this income across pay, spend and save sub-accounts. The pay sub-account may be used for paying bills while the spend sub-account is used for spending on non-bill related items, such as gas, grocery, pharmacy, clothing and entertainment, etc. The save sub-account may be for savings for certain events, such as a vacation, holiday shopping or retirement. Income flows into the account are automatically allocated and provided to these sub-accounts.

Execution of the planned allocation of income across these sub-accounts is seamlessly implemented via a plurality of banking tools that are part of the same account. The CFM account may use any one or more bill paying tools for the pay account, any one or more prepaid debit or other financial cards for the spend account and any type and form of savings accounts for the save sub-accounts. Via the CFM, a user may monitor or update their cash flow in real-time, or even enter hypothetical payments, expenses, or savings goals to predict their impact on cash flow.

In some aspects, the present solution is directed to a method for automatically managing cash flow of a household. The method includes identifying, by a cash flow manager executing on one or more servers, receipt of an amount of income from one or more sources of income of a household into a household account. The household account includes a pay sub-account, a spend sub-account and a save sub-account. The method also includes allocating automatically, by the cash flow manager responsive to the receipt of the amount of income, amounts from the amount of income into each of the pay sub-account, the spend sub-account and the save sub-account of the household account in accordance with a cash flow management plan of the household stored in association with the household account maintained by the cash flow manager. The method also includes tracking, by the cash flow manager, use of cash by the household across each of the pay sub-account, the spend sub-account and the save sub-account against a corresponding sub-account budget plan of the cash flow management plan for the household account.

The method also includes receiving, by a user interface of the cash flow manager from a user of the household account, information to establish in the cash flow management plan a spending budget plan for the spend sub-account, a pay plan for the pay sub-account and a savings plan for the save sub-account. The method also includes identifying, by the cash flow manager, receipt of a monthly electronic deposit into the household account of a predetermined amount of income.

The method includes automatically executing, by the cash flow manager, a transaction to fund a financial card of a user of the household with a spending amount in accordance with a spending budget plan and based on the allocation of an amount from the amount of income to the spend sub-account. The method includes enforcing, by the cash flow manager, spending via the financial card in accordance with the spending budget plan by only authorizing one or more vendors to deduct funds from the financial card based on whether the vendors sells items falling with one or more predetermined categories of the spending budget plan. The method also includes automatically executing, by the cash flow manager, one or more transactions to electronically pay bills of the household in accordance with a pay budget plan and based on the allocation of an amount from the amount of income to the pay sub-account. The method also includes automatically executing, by the cash flow manager, one or more transactions with one or more payment processors to electronically pay bills of the household in accordance with a pay budget plan and based on the allocation of an amount from the amount of income to the pay sub-account. The method also includes automatically applying, by the cash flow manager, predetermined amounts of funds allocated to the save sub-account to one or more goals in accordance with a save budget plan and based on the allocation of an amount from the amount of income to the save sub-account.

The method also includes automatically identifying, by the cash flow manager, any funds in the household account that are remaining after amounts from the amount of income have been allocated to each of the pay sub-account, spend sub-account and save sub-account in accordance with the respective sub-account budget plans. The method also includes generating, by the cash flow manager, a cash flow forecast based on budgeted and actual use of cash by the household across each of the pay sub-account, the spend sub-account and the save sub-account.

In some aspects, the present solution is directed to a system for automatically managing cash flow of a household. The system includes a cash flow manager executing on one or more servers and a household account maintained by the cash flow manager. The household account includes a pay sub-account, a spend sub-account and a save sub-account of a household. The system may include a cash flow management plan of the household configured via the cash flow manager and stored in association with the household account. The cash flow manager identifies receipt of an amount of income from one or more sources of income of a household into the household account and responsive to the receipt of the amount of income, the cash flow manager automatically allocates amounts from the amount of income into each of the pay sub-account, the spend sub-account and the save sub-account of the household account in accordance with the cash flow management plan. The cash flow manager tracks use of cash by the household across each of the pay sub-account, the spend sub-account and the save sub-account against a corresponding sub-account budget plan of the cash flow management plan for the household account.

The system may include a user interface of the cash flow manager which receives from a user of the household account information to establish in the cash flow management plan a spending budget plan for the spend sub-account, a pay plan for the pay sub-account and a savings plan for the save sub-account. In many embodiments, the cash flow manager identifies receipt of a monthly electronic deposit into the household account of a predetermined amount of income.

In some embodiments, the cash flow manager automatically executes a transaction to fund a financial card of a user of the household with a spending amount in accordance with a spending budget plan and based on the allocation of an amount from the amount of income to the spend sub-account. In some embodiments, the cash flow manager enforces spending via the financial card in accordance with the spending budget plan by declining transactions in specified categories over a predetermined amount within a given time frame for example within a certain month. In some embodiments, the cash flow manager automatically executes one or more transactions to electronically pay bills of the household in accordance with a pay budget plan and based on the allocation of an amount from the amount of income to the pay sub-account. In some embodiments, the cash flow manager automatically executes one or more transactions with one or more payment processors to electronically pay bills of the household in accordance with a pay budget plan and based on the allocation of an amount from the amount of income to the pay sub-account. In some embodiments, the cash flow manager automatically applies predetermined amounts of funds allocated to the save sub-account to one or more goals in accordance with a save budget plan and based on the allocation of an amount from the amount of income to the save sub-account. In some embodiments, the cash flow manager automatically identifies any funds in the household account that are remaining after amounts from the amount of income have been allocated to each of the pay sub-account, spend sub-account and save sub-account in accordance with the respective sub-account budget plans. In some embodiments, the cash flow manager generates a cash flow forecast based on budgeted and actual use of cash by the household across each of the pay sub-account, the spend sub-account and the save sub-account.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client machines in communication with remote machines;

FIGS. 1B and 1C are block diagrams depicting embodiments of computing devices useful in connection with the methods and systems described herein;

FIG. 2A is a diagram illustrating a methodology of the cash flow management system;

FIGS. 2B and 2C are block diagrams depicting embodiments of a cash flow management system;

FIG. 3A is a flow diagram depicting an embodiment of a method of the cash flow management system;

FIGS. 3B-3Q depict various embodiments of elements in FIG. 3A; and

FIGS. 4A-4X depict various embodiments of the cash flow management system.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein; and
Section B describes embodiments of systems and methods for providing a cash flow management system.

### A. Computing and Network Environment

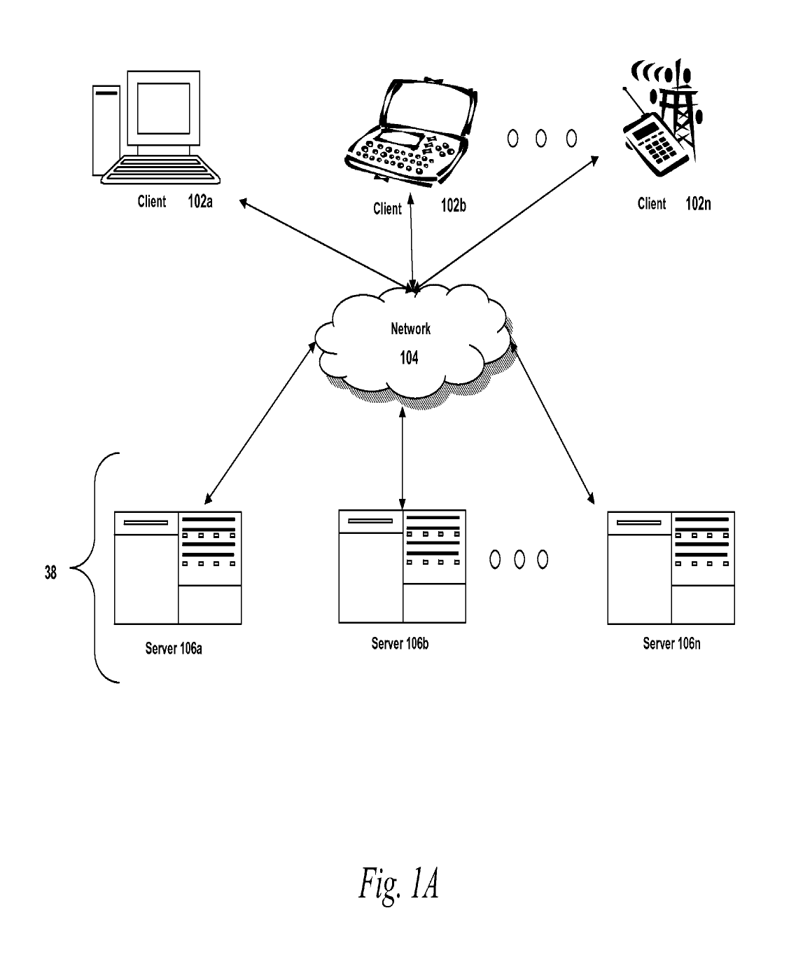

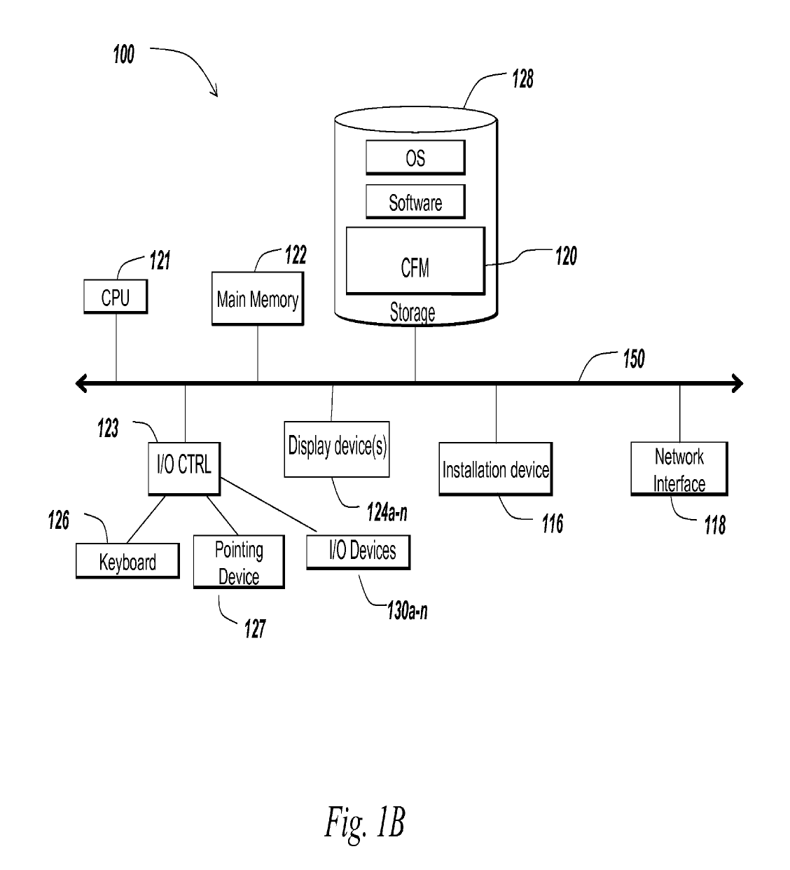

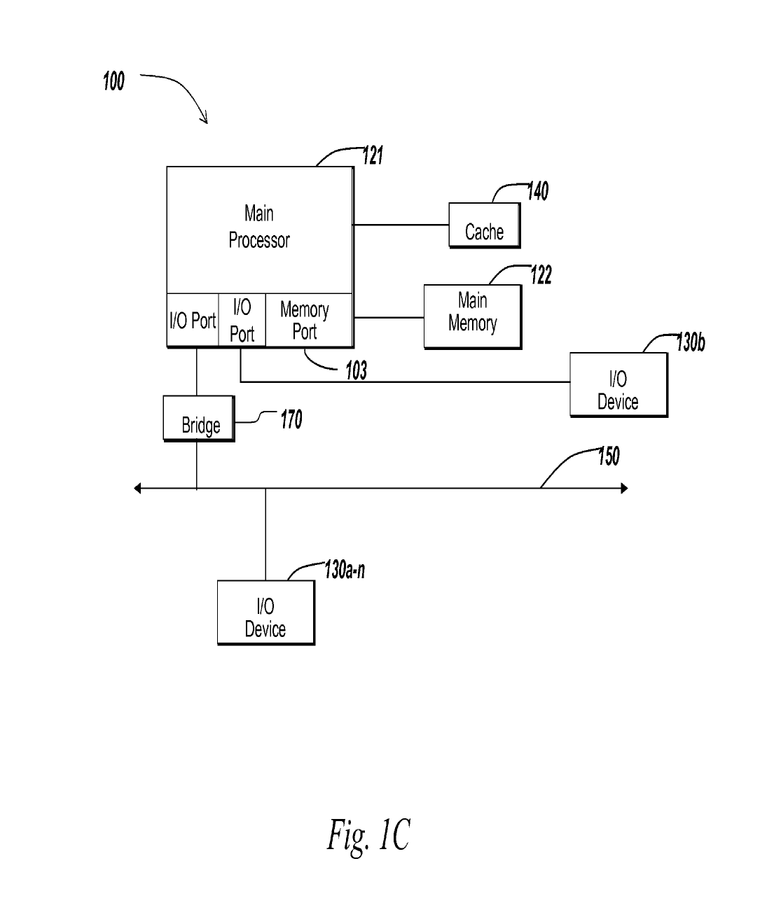

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n. In another embodiment, the network environment may be configured for cloud computing, whereby shared resources, software, and information are provided to clients 102a-102n via one or more networks 104.

Although FIG. 1A shows a network 104 between the clients 102 and the servers 106, the clients 102 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix or Linux).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the VirtualServer or virtual PC hypervisors provided by Microsoft or others.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

The client 102 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-102n, a keyboard 126 and a pointing device 127, such as a mouse. The storage device 128 may include, without limitation, an operating system, software, and a software of a cash flow management system 120. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, a flash memory drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the software 120 for the cash flow management system. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, WINDOWS VISTA, and WINDOWS 7, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPOD, IPHONE, or APPLE TV family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED, NINTENDO REVOLUTION, or a NINTENDO WII device manufactured by Nintendo Co., Ltd., of Kyoto, Japan, an XBOX or XBOX 360 device manufactured by the Microsoft Corporation of Redmond, Wash.

In some embodiments, the computing device 100 may have different processors, operating systems, and input devices consistent with the device. For example, in one embodiment, the computing device 100 is a TREO 180, 270, 600, 650, 680, 700p, 700w, or 750 smart phone manufactured by Palm, Inc. In some of these embodiments, the TREO smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95cl, or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, and IPOD NANO lines of devices, manufactured by Apple Computer of Cupertino, Calif. In another of these embodiments, the digital audio player may function as both a portable media player and as a mass storage device. In other embodiments, the computing device 100 is a digital audio player such as the DigitalAudimpression opportunity layer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the Zen Vision W, the Zen Vision series, the Zen Portable Media Center devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the communications device 102 includes a combination of devices, such as a mobile phone combined with a digital audio player or portable media player. In one of these embodiments, the communications device 102 is a smartphone, for example, an iPhone manufactured by Apple Computer, or a Blackberry device, manufactured by Research In Motion Limited. In yet another embodiment, the communications device 102 is a laptop or desktop computer equipped with a web browser and a microphone and speaker system, such as a telephony headset. In these embodiments, the communications devices 102 are web-enabled and can receive and initiate phone calls. In other embodiments, the communications device 102 is a Motorola RAZR or Motorola ROKR line of combination digital audio players and mobile phones.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Cash Flow Management System

Systems and methods of the present solution is directed to a cash flow management (CFM) system that manages cash flow for a household. Households typically have multiple sources of financial income, recurring payees and expenses, and goals for savings. Embodiments of the CFM of the present solution provides a single integrated tool to automatically, holistically and seamlessly plan, execute and manage cash flow for a household.

The CFM uses a methodology of sub-accounts managed under a CFM account. The sub-accounts may be allocated or designed for pay, spend and save related activities. The pay sub-account may be used for planning, executing and managing the portion of the cash flow related to paying any type and form of bills. The spend sub-account may be used for planning, executing and managing the portion of the cash flow related to spending activities of the household, such as for non-bill related items (e.g., food shopping, consumable items, etc) and discretionary spending. The save sub-account may be used for planning, executing and managing the portion of the cash flow related to saving, such as for specific events (e.g., a car, vacation or retirement). The CFM automates income flows of funds and allocation from plan to pay, spend and save sub-accounts within same account. The CFM enables holistic planning, execution, management and real-time tracking of household cash flow across pay, spend and save sub-accounts.

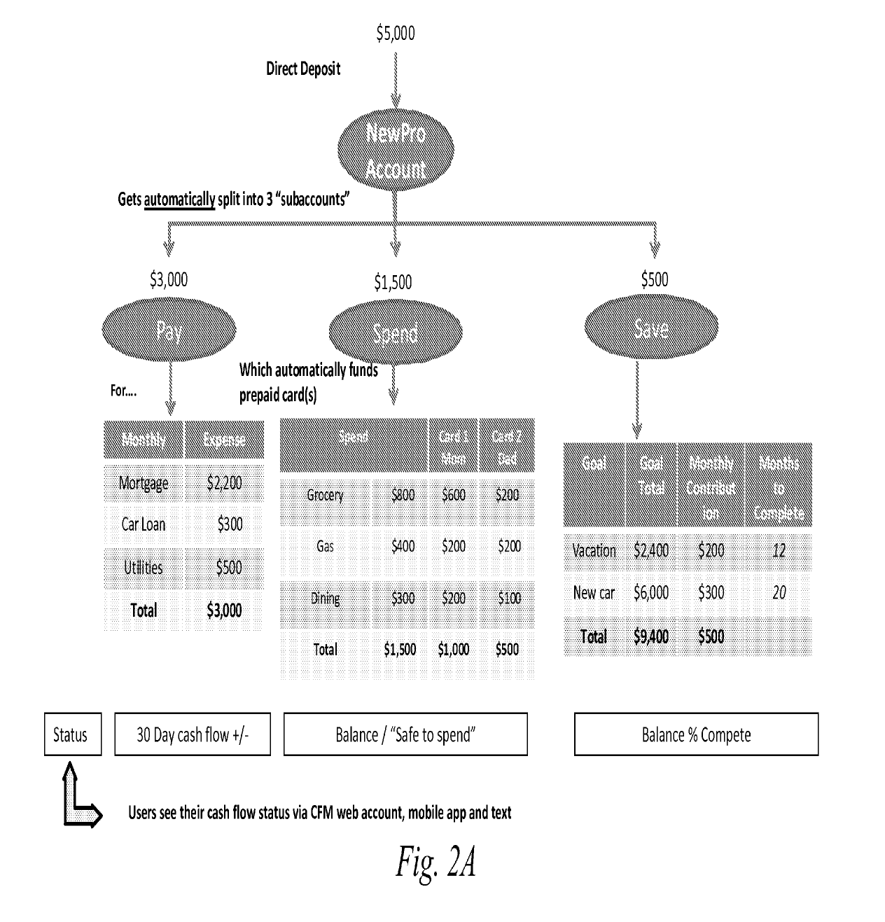

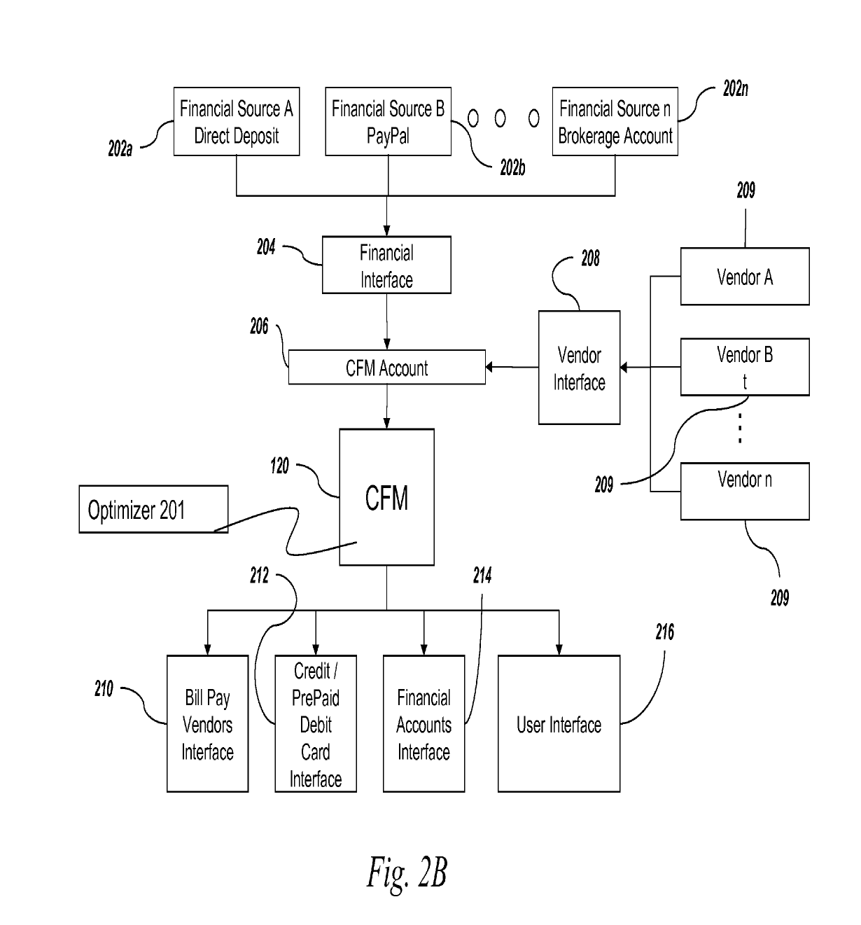

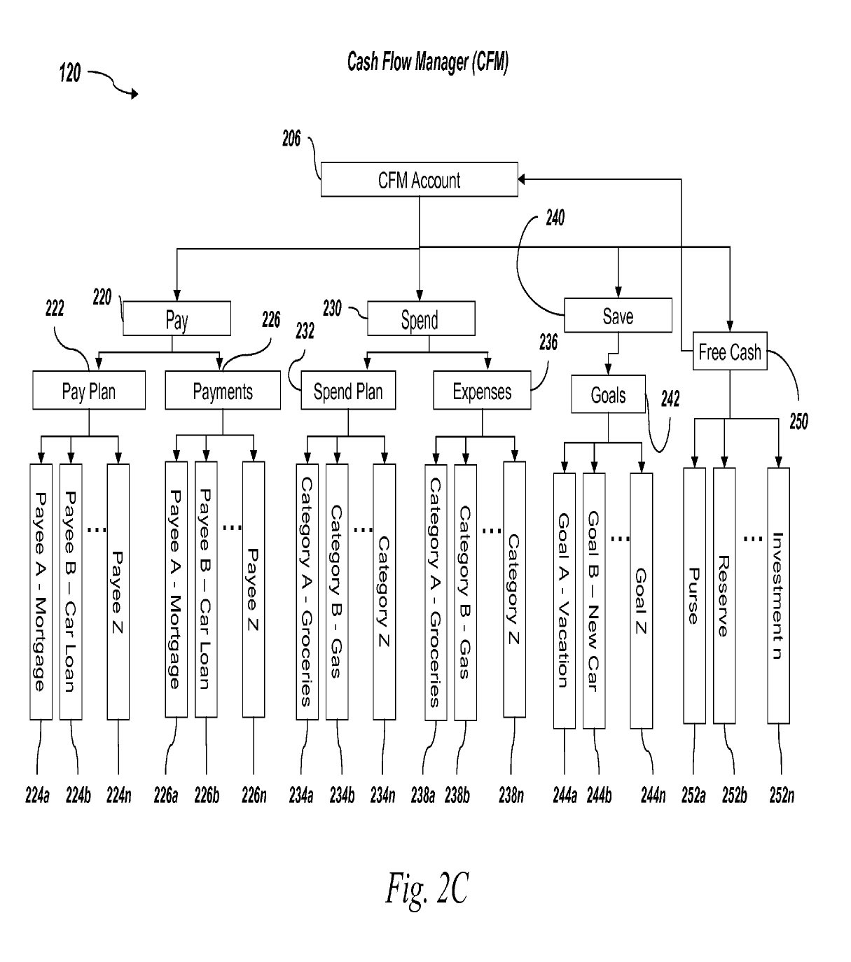

Prior to discussing specific embodiments of the systems and methods of the CFM of the present solution, it may be useful to illustrate an example use of the CFM. Referring now to FIG. 2A, is an example of a household cash flow under management of the CFM. The CFM account may receive income from an income source, such as one or more direct deposit from work. In this example, the CFM account receives a $5,000 per month as a direct deposit. Via the CFM, a user of the household has planned for $3000 across three categories under the pay account, including mortgage, car loan and utilities. The user of the household has planned for $1500 across three categories under the spend account, including gas, grocery and dining. The user of the household has planned for $500 across two events under the save account, including vacation and car.

Based on the allocation planning of the household, the income is automatically allocated across the pay, spend and save sub-accounts, sometimes generally referred to as accounts. Based on the plan, $3000 of the $5000 is allocated to the pay account, $1500 of the $5000 is allocated to the spend account and $500 is allocated to the save account. Under the spend account, the user may have planned for each category to further allocate the flow of income across multiple prepaid cards. For example, under the grocery category of the spend account illustrated in FIG. 2A, the user planned for $600 out of the $800 to the mother's card and $200 out of the $800 to the father's card. As such, the CFM executes the plan and automatically funds the respective cards of the mother and father according to the configured allocation. Under the save account, the user may have planned for each category to further allocate the flow of income across saving events. For each saving event, the user may have planned for a goal based on a monthly contribution and total saving goal. For example, the user may plan for a new car with a total goal of saving $6000 by contributing $300 month for 20 months. Each saving event may have a “purse” associated with the event, which may include an allocation to a financial, bank or other form of saving account. Accordingly, the CFM executes the plan and allocates a portion of the save account allocation to each saving event based on the save account plan.

During execution of the monthly cash flow plan, the CFM monitors, tracks and updates the actual use of cash according to the plan. A user may receive text on the mobile devices or phones providing alerts on activity and status of the CFM account. The user may use a mobile application, referred to as an app, to interface with the CFM account and receive activity and status updates. The user may also interface with the CFM account via a web-site of the CFM.

CFM may provide real-time status and updates regarding the comparison of pay account budget plan to actual amount of bills paid. As such, the user may view whether or not there is a positive or negative cash flow for the pay account. Likewise, the CFM may provide real-time status and updates regarding the comparison of the spend account budget plan to actual amounts spent such as via prepaid cards. As such, the user may view whether or not there is a balance or funds remaining that are free to spend under the spend account. The CFM may provide real-time status and updates regarding the comparison of the save account plan to actual amounts saved. As such, the user may view the percentage complete towards each saving goal.

Referring to FIG. 2B, embodiments of a system for cash flow management is depicted. In brief overview, the CFM 120 may include a plurality of accounts 206 for each household to plan, execute and manage cash flow for the household. The CFM provides a user interface 216 for a user to perform cash flow management and view the status and activity of execution of the plan. The CFM may interface or provide an interface 204 to any type and form of financial account, such as bank, savings or investment account. The CFM may interface via a financial interface 204 to multiple cash flow input sources and output destinations 202a-202n from which the account 206 may be funded, or where funds from account 206 may be deposited. The CFM may interface via a financial data interface 208 to a plurality of data sources 209 to receive information on cash flow activity, such as retail activity and UPC level information of purchases, or any other external financial information that may improve the CFM's functionality or user experience. The CFM may interface to any type and form of bill paying service or otherwise provide a bill paying interface 210. The CFM may interface to any type and form of debit, prepaid or credit card service or otherwise provide such an interface 212. In some embodiments, the CFM may enforce borrowing so that a user may only borrow after having planned and automated a payback. The CFM may include a cash flow optimizer 201 to optimize current and/or future cash flow.

In further detail, the CFM may include a financial interface 204 designed and constructed to interface to any type and form of financial account or income source. The financial interface may comprise an application, program, library, script, service, process, task or any type and form of executable instructions executing on a device. In some embodiments, the financial interface 204 is designed and constructed to obtain, transfer or direct the funds from the various financial sources 202 to a centralized cash flow management account 206. In some embodiments, the financial interface 204 is designed and constructed to identify and/or remotely manage the funds from the various financial sources 202 via a centralized cash flow management account 206. In some embodiments, the financial interface 204 is designed and constructed to obtain, transfer or direct the funds from the CFM Account 206 to a financial destination 202. The interface may employ a network 104 and utilize software running on a client 102 and server 106. In some embodiments, the software, resources, and information necessary for the interface may be provided via cloud computing. The financial interface 204 may use any type and form of electronic exchange specification, interface and/or protocols, such as the widely used Open Financial Exchange standard created by Microsoft of Redmond, Wash., Intuit of Mountain View, Calif., and CheckFree (which was acquired by Fiserv of Brookfield, Wis.). One of ordinary skill in the art will readily recognize the various methods, services, or systems 204 that may facilitate the transfer of funds from a plurality of sources 202 into an account 206.

A household's cash flow input 202a-202n may be any type and form of income or financial source including but not limited to direct deposit from an employer into a bank account, PayPal, Automated Clearing House, remote deposit capture, or a reload network. The financial interface may be adapted, configured or designed and constructed to interface to the plurality of heterogeneous incomes sources. In some embodiments, the financial source may be in the form of cash or checks that are deposited into an account or otherwise wired or transferred to an account. Financial sources or destinations may also be brokerage accounts, insurance accounts, or social security payments.

The financial data interface 208 may be designed and constructed to interface, communicate with or integrate to a plurality of data sources. The financial data interface may comprise an application, program, library, script, service, process, task or any type and form of executable instructions executing on a device. The interface may employ a network 104 and utilize software running on a client 102 and server 106. The financial data interface 208 may provide information from a plurality of data sources 209 to the CFM Account 206. A data source may be a vendor, which may include any entity from which a household may perform any type and form of financial transaction regarding the purchasing of products and/or services, such as a retailer, credit card company, card processor, etc. In some embodiments, the data source may be information located on a server that is accessible through the network, or the data source may be information stored in a database on a client. In some embodiments, the interface can use authentication information provided by the CFM to gain access to a protected data source. In some embodiments, the information provided via some data sources may conform at least in part to some standards. In certain embodiments, the information provided by a data source may be specific to that data source's custom or semi-custom interface. The availability and type of information provided by data sources may vary, e.g., from grocery store to clothing store. Some data sources may provide support for requesting or querying different types or granularity of data.

Via the financial data interface, the CFM may obtain and use information from a data source regarding a household's historical, current, or anticipated purchases, bills, or other expenses to facilitate the planning, monitoring and enforcement of a household's cash flow. In one embodiment, the information that is provided via this interface may comprise statistical information that may be used by the CFM to assist a user in developing a cash flow plan. For example, the CFM may request, through the interface, statistical information related to the amount a family spends on groceries in a given zip code. The interface may be used to search among a plurality of public and private data sources, including sources containing information on other CFM users.

In another embodiment, the information provided via this interface may comprise a user's purchase information, including identification of products, categories of products and/or prices of products. The information may include UPCs (Universal Product Code) for items purchased by the household. In another embodiment, the information may comprise electronic receipts from online vendors. In yet another embodiment, this interface 208 may be used to input physical copies of receipts from data sources 209 to the CFM account 206 in a machine readable format. This embodiment of the interface may utilize a scanner and a software module running on either a client or server that performs optical character recognition. Some embodiments of this interface 208 may provide the CFM account 206 with real-time information. Some embodiments of this interface 208 may also permit the CFM 120 to control a household's spend behavior consistent with a plan established by the household, which will be further discussed herein.

The CFM 120 uses the information available in the CFM account 206 to automatically implement, enforce, or monitor a household's cash flow plan, as stored in the CFM account 206, via bill pay vendor interface 210, credit card or prepaid debit card interface 212 and financial interface 204. The interfaces 210, 212 and 204 may comprise an application, program, library, script, service, process, task or any type and form of executable instructions executing on a device.

The CFM via any of the interface may interface to or communicate with any financial or payment processor in connection with any one or more financial or payment networks. In some embodiments, the CFM interfaces with a credit card processor in connection with any credit card network, such as Visa or Mastercard. In some embodiments, the CFM interfaces with a debit payment processor in connection with any debit network. In some embodiments, the CFM interfaces with an ATM card processor in connection with any ATM network. Front-end processors have connections to various card associations and supply authorization and settlement services to the merchant banks' merchants. Back-end processors accept settlements from front-end processors and, via The Federal Reserve Bank, move the money from the issuing bank to the merchant bank.

In an operation that may take a couple of seconds or less, the payment processor will both check the details received by forwarding them to the respective card's bank issuing bank or card association for verification, and also carry out a series of anti-fraud measures against the transaction. Additional parameters, including the card's country of issue and its previous payment history, are also used to gauge the probability of the transaction being approved. Once the payment processor has received confirmation that the credit card details have been verified, the information will be relayed back via the payment gateway to the merchant, who will then complete the payment transaction. If verification is denied by the card association, the payment processor will relay the information to the merchant, who will then decline the transaction.

Via the payment processor and the payment processor's networks, one or more services may be offered and/or provided to users of the CFM. In some embodiments, the CFM may offer and/or provide to CFM users one or more services via the payment processor and the payment processor's networks. For example, credit may be offered to the CFM users, such as via a preapproved credit card. In some cases, financial services may be offered to a CFM user based on information on the user available via the CFM. In some embodiments, the CFM may target financial products and/or services available via a payment processor and/or payment network based on CFM user information, use of the CFM product, cash flow management history, etc.

The bill pay vendor interface 210 may be designed and constructed to interface, communicate with or integrate to a plurality of bill pay vendors or directly with payees. The financial data interface may comprise an application, program, library, script, service, process, task or any type and form of executable instructions executing on a device. The interface may employ a network 104 and utilize software running on a client 102 and server 106. The bill pay vendor interface 210 may direct cash flow to a plurality of bill pay vendors or directly with payees. A bill pay vendor may include any entity that can pay a bill electronically or physically, such as the Online Bill Pay Service of Bank of America of Charlotte, N.C., or the MyCheckFree service by Fiserv of Brookfield, Wis. In some embodiments, the CFM may interface directly with a payee via the bill pay vendors interface 210. A direct payee may be any entity that bills a user, such as a cable television company or a cell phone company. The bill pay vendors interface can interface directly with a payee's preferred payment method, such as the online bill pay service of Comcast Corporation of Philadelphia, Pa. In some embodiments, the bill payer vendor is the bill pay entity or service integrated or associated with the processor. In these embodiments, the CFM interfaces to, communicates with or otherwise uses the bill pay services of the processor. In some embodiments, the system of directing funds to a bill pay vendor or payee may conform at least in part to some standards. In certain embodiments, the systems and methods used to direct funds may be electronic, physical, or a combination of both. In some embodiments, the interface can automatically exchange the currency to the local bill pay vendor or payees preferred currency.

In another embodiment, the bill pay vendor interface 210 may be designed and constructed to interface, communicate with or integrate to one or more payment processors. A payment processor may be any third-party entity that handles credit, prepaid/debit card transactions. In one embodiment, the processor may have connections to various card associations and supply authorization and settlement services to a CFM user. In another embodiment, the payment processor may accept settlements from a CFM user, via a payment processor, and direct funds from the issuing bank to a CFM account or a merchant's bank.

Via the bill pay vendor interface 210, the CFM may automatically direct funds in the CFM Account to a plurality of payees. In some embodiments, the CFM may use the interface to provide a bill pay vendor with information necessary to pay a bill, e.g., payees' names and mailing addresses or account information, amounts owed, and due dates. The CFM may use the interface to update this information as needed or as directed by the user. In some embodiments, the CFM may use the interface to direct cash flow from the CFM account 206 to the bill pay vendor along with necessary information to pay a bill. In some embodiments, the bill payment system may be internal to the CFM, and the bill pay vendors interface can be used to make payments directly to payees when they are due, when the user directs the payments to be made, or when any predetermined condition is met. The CFM can also use the interface to directly make a payment to a vendor. For example, the CFM may use the interface to direct cash flow and necessary information directly to a company or individual, either to their financial account or via mailing a physical check to their mailing address.

In some embodiments, a bill pay vendor or payee may send information to the CFM via the bill pay vendors interface 210. For example, the bill pay vendor or payee may notify the CFM of whether a payment was successfully received on time, when a payment is due, or any other information that a bill pay vendor or payee may have that may be beneficial to the CFM or user experience.

The credit/prepaid debit card interface may be designed and constructed to interface, communicate with or integrate to a plurality of credit and prepaid debit cards, or third party vendors that provide credit and prepaid debit cards. The interface may be designed and constructed to interface with an automated teller machine and/or a credit/debit card machine. The CFM may use authentication information to successfully interface with credit and prepaid debit cards, or credit and prepaid debit card vendors. The interface may comprise an application, program, library, script, service, process, task or any type and form of executable instructions executing on a device. The interface may employ a network 104 and utilize software running on a client 102 and server 106.

Via the credit/prepaid debit card interface, the CFM may direct, monitor and control cash flow on credit and prepaid debit cards. In some embodiments, the CFM may use the interface to instruct a third party card vendor to provide a user with a credit/prepaid debit card. The CFM may, via the interface, provide the card vendor with any information that may be used to create the card. For example, the CFM may, via the interface, instruct the vendor to provide a user with a prepaid debit card with a $100 per week limit that can only be used at a Star Market or Trader Joe's. In some embodiments, the interface may update the CFM as to the current balance status of the card.

The CFM may provide, issue or otherwise recognize one or more credit and/or debt cards for use with the CFM system. In some embodiments, the CFM may provide a CFM branded card or affinity card. In some embodiments, one or more credit and/or debit card may be used to access, control and manage the user's CFM account. The CFM may work in conjunction with one or more cards to monitor, track and enforce a household plan. In some embodiments, the CFM based card is designed to work in conjunction with the CFM system to enforce the spending limits in the spending plan. In some embodiments, the CFM based card is designed to work in conjunction with the CFM system to enforce the spending limits on a per category basis as specified via the spending plan. In some embodiments, the CFM based card is designed to work in conjunction with the CFM system to enforce the spending limits on a per category and per user basis as specified via the spending plan. As such, in some embodiments, a purchase transaction via a CFM recognized card may interface via any type and form of processor to determine via the CFM whether the purchase is allowed or granted based on the spending plan. In some embodiments, a purchase transaction via a CFM recognized card may interface via any type and form of processor to provide purchase tracking information to the CFM.

The user interface 216 may be any type or form of interface, such as a graphical user interface (GUI) and/or a command line interface. The interface may be a web interface. The interface may be an application interface. The interface may be a text interface via texting, instant messaging, chatting and the like. The interface may be an application executing on a mobile device. Portions of the interface and interface content may be provided by a locally-executing application (e.g., software program) on a client machine 102. Portions of the interface and interface content may be remotely transmitted from a server 106 to a client machine 102 for presentation (e.g., on a browser executing on the client machine 102).

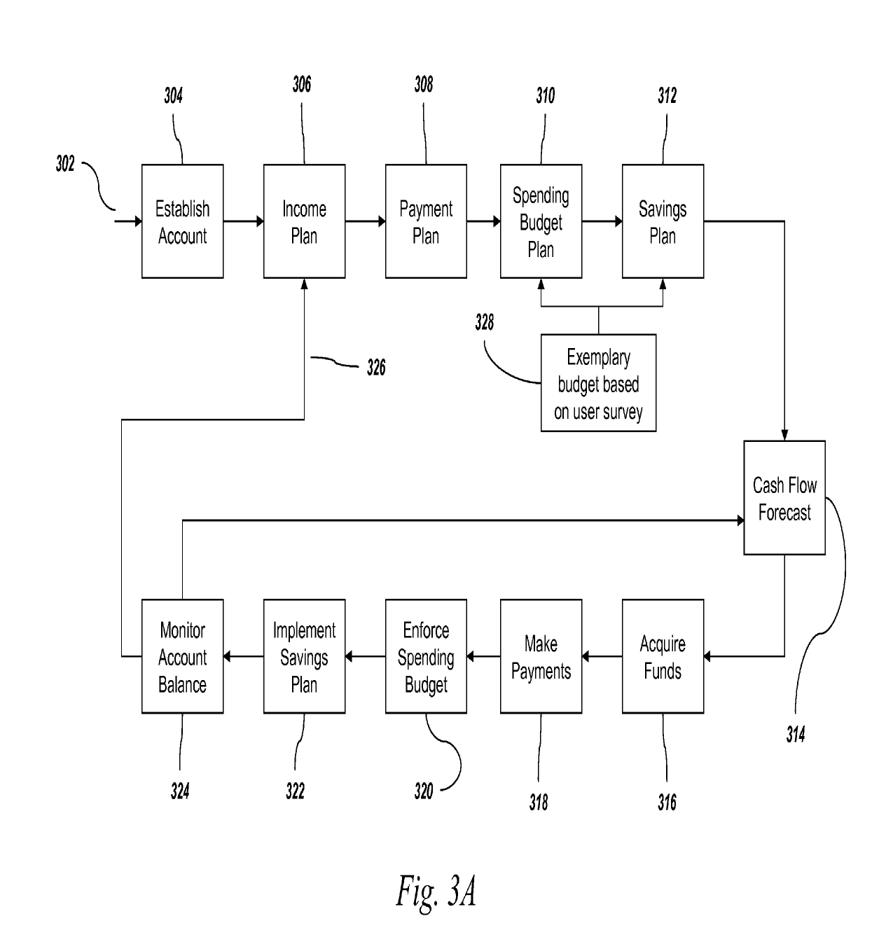

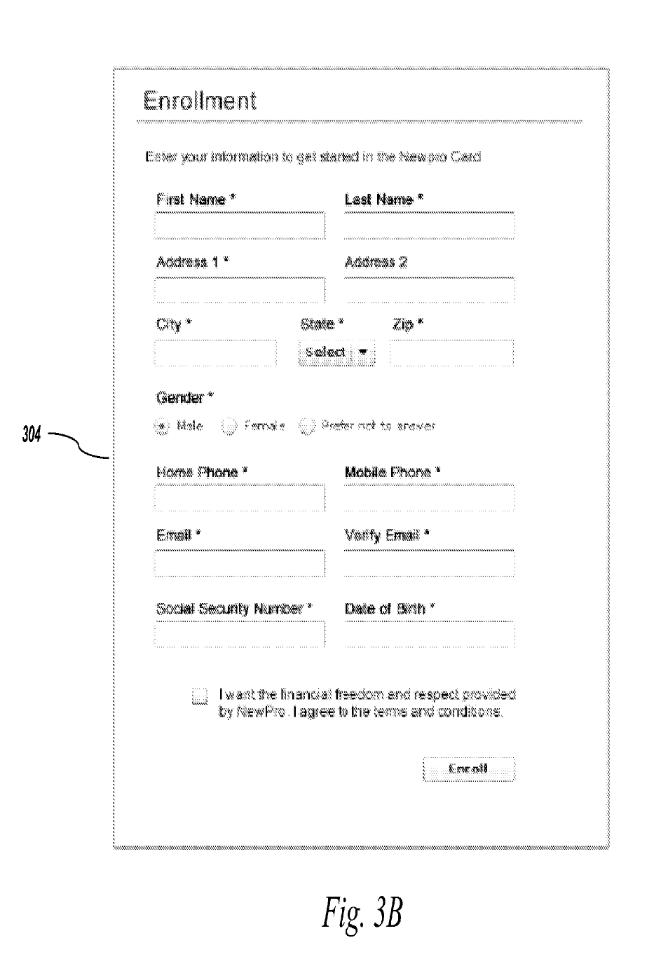

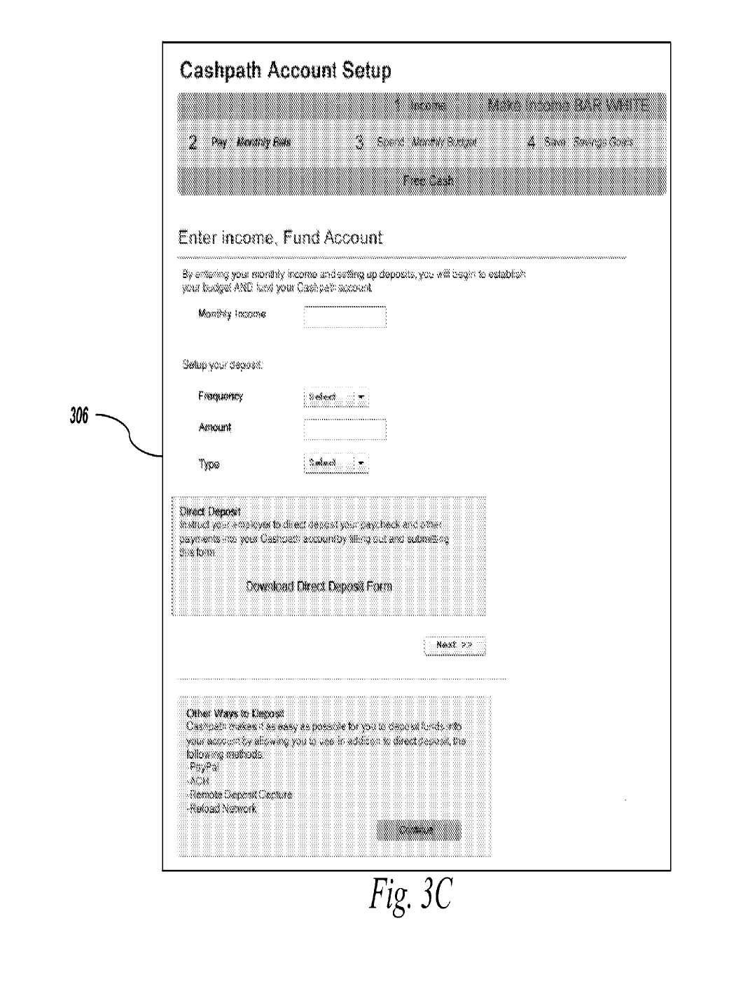

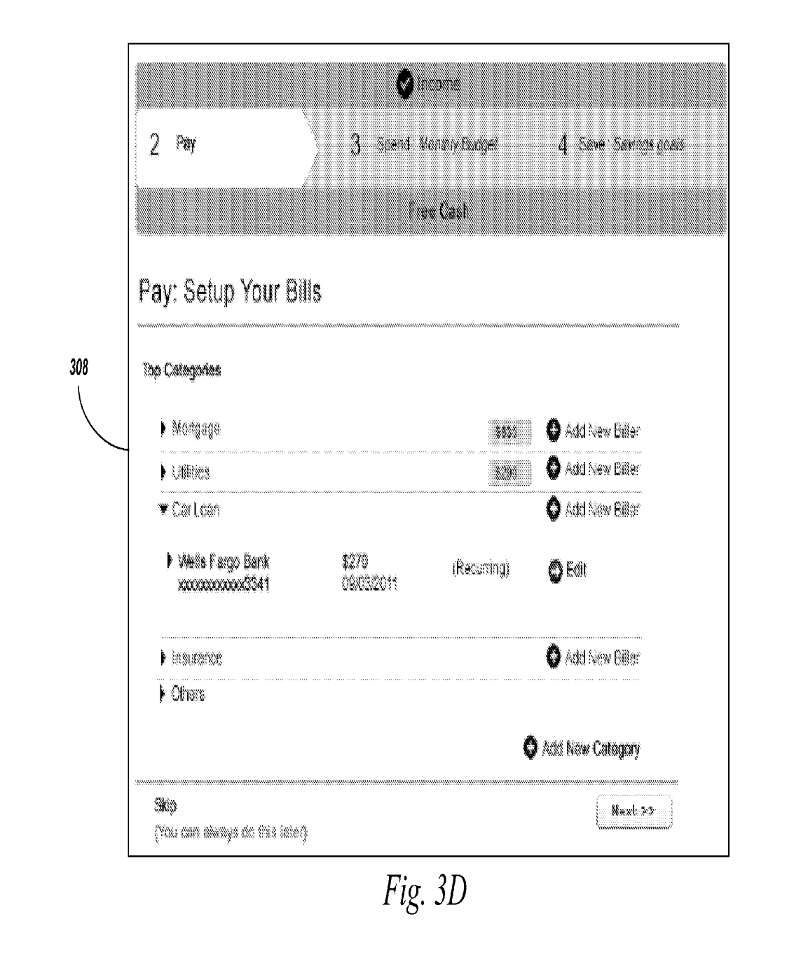

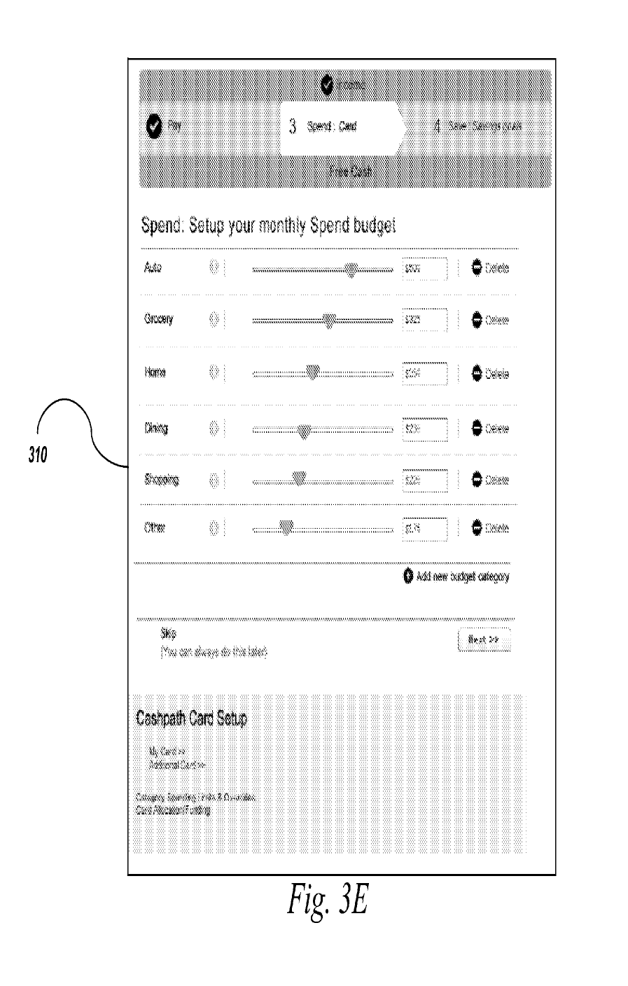

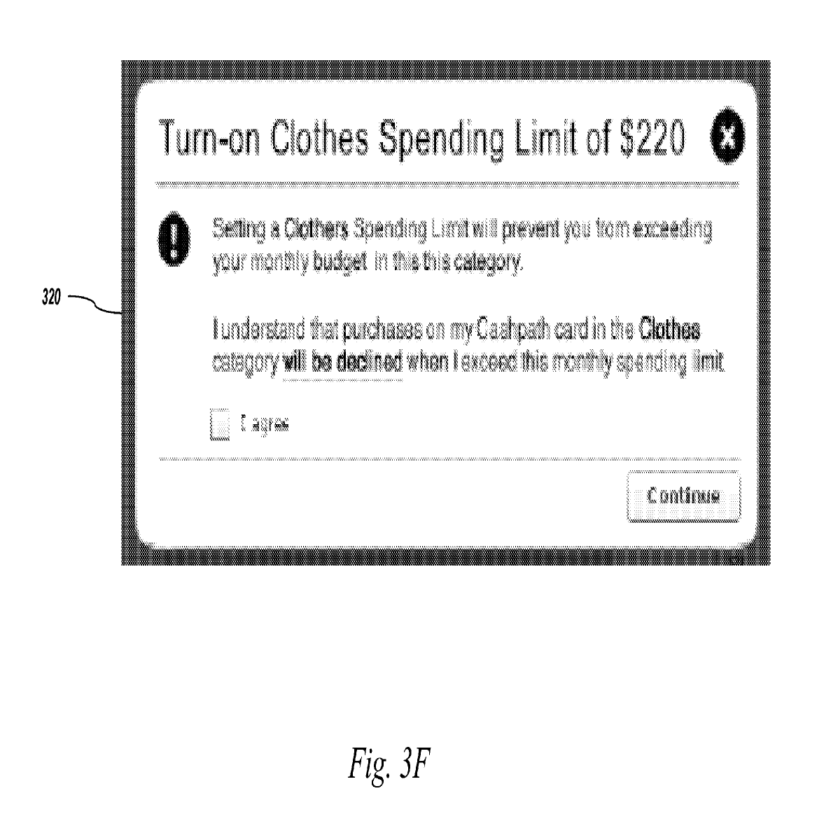

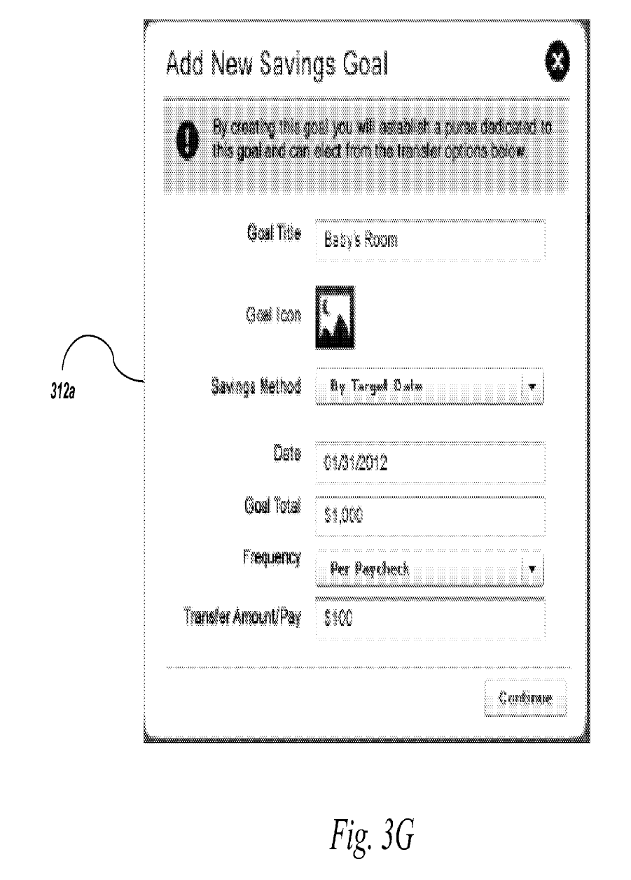

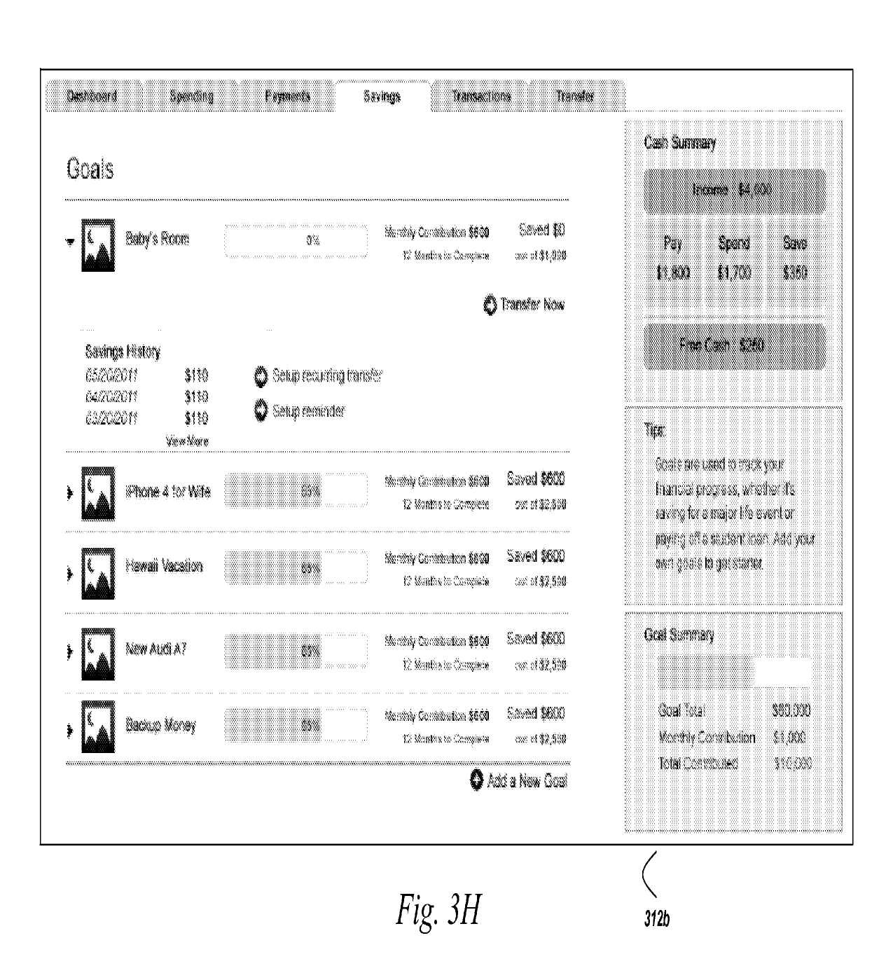

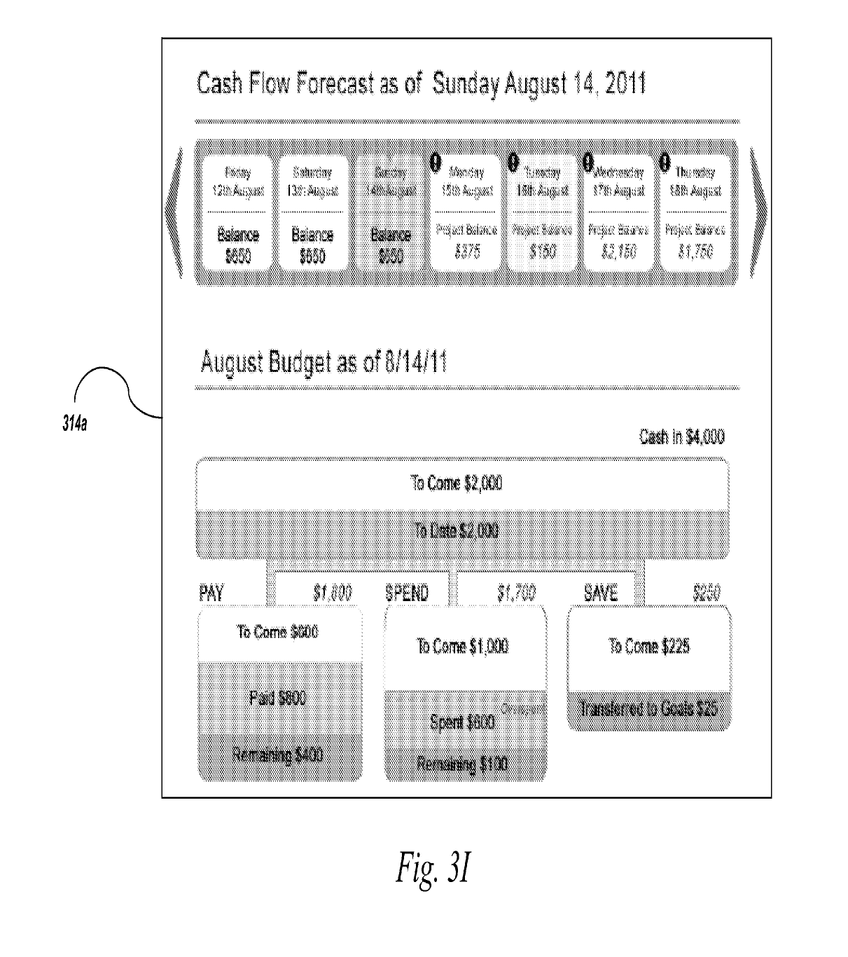

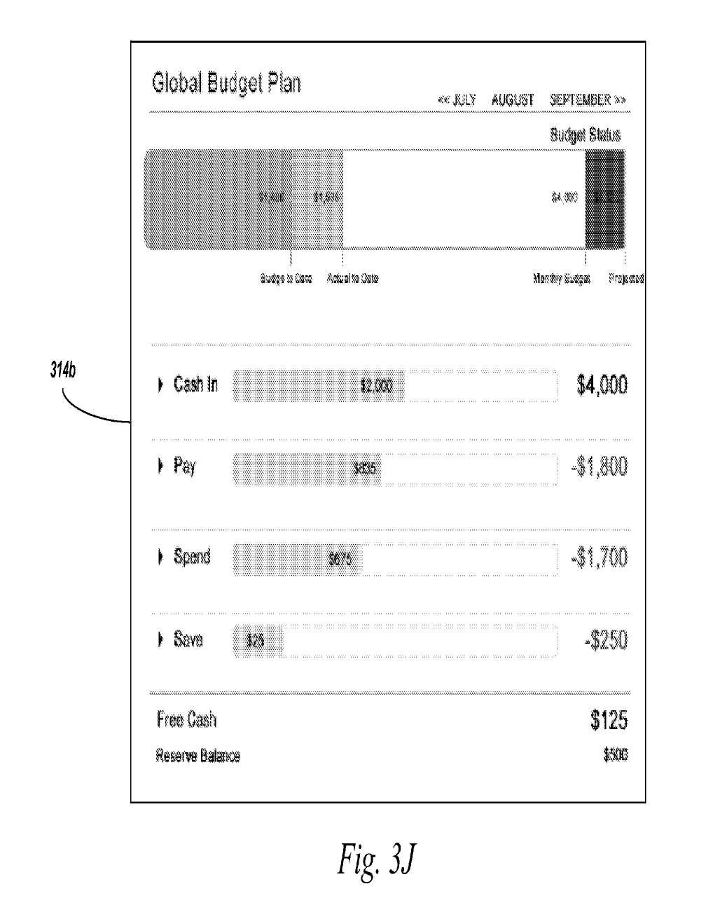

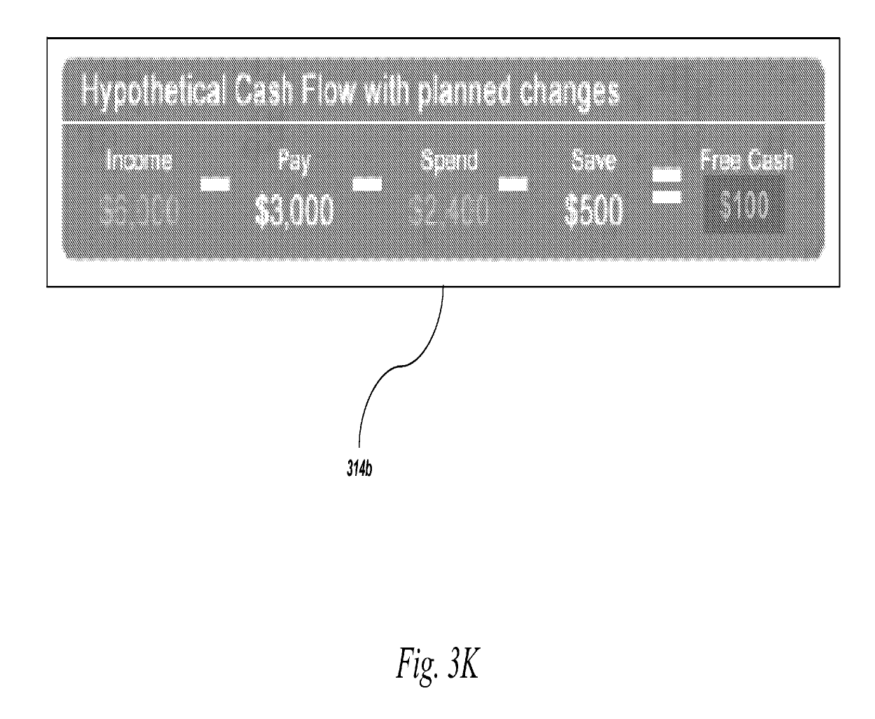

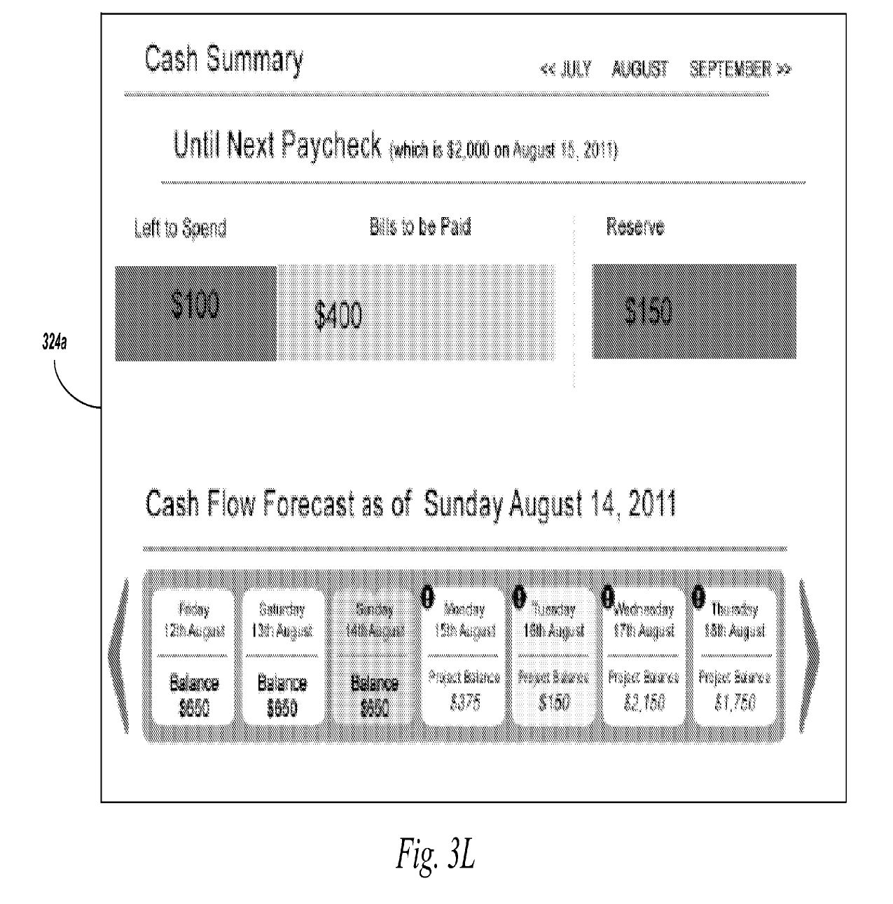

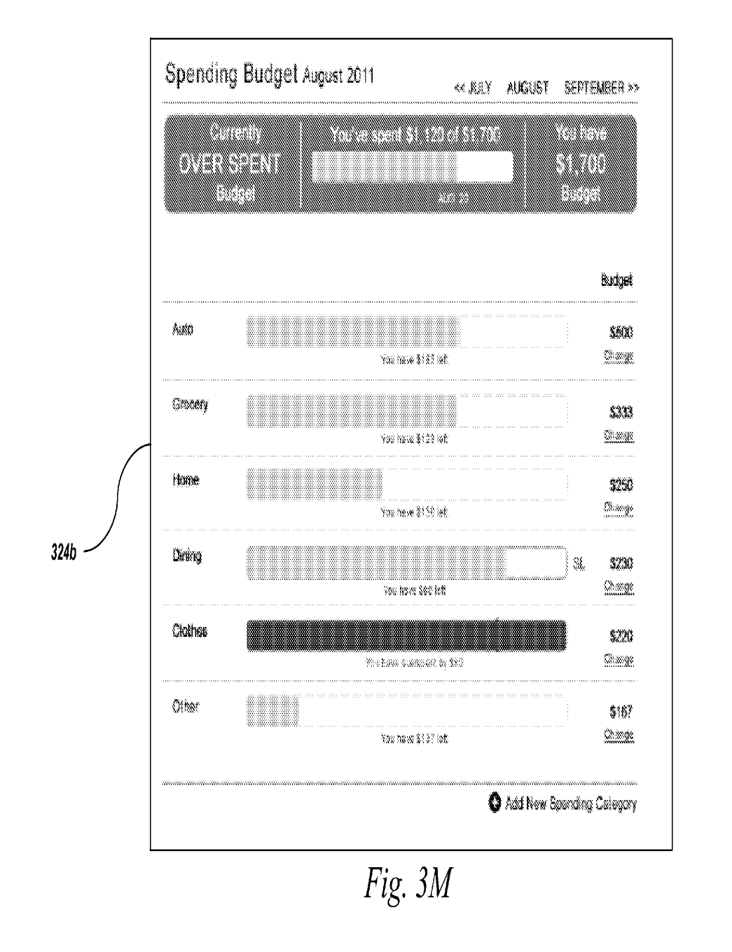

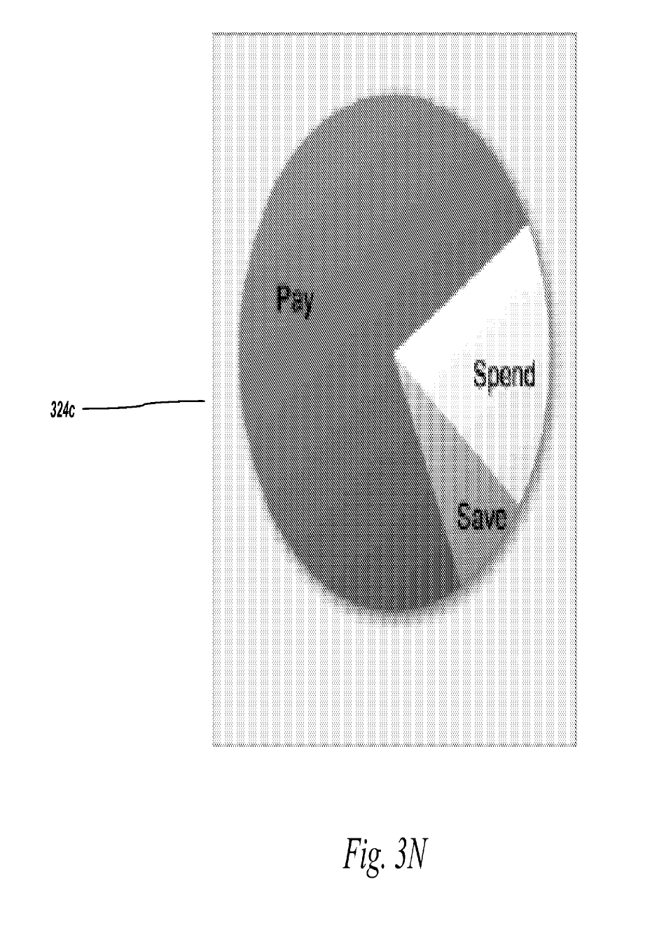

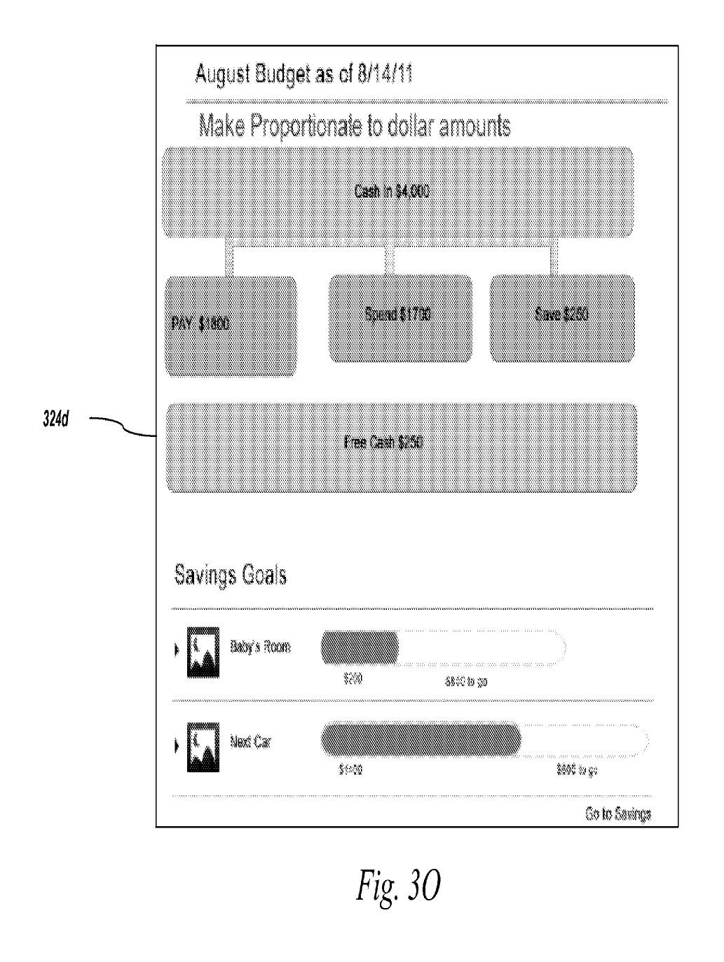

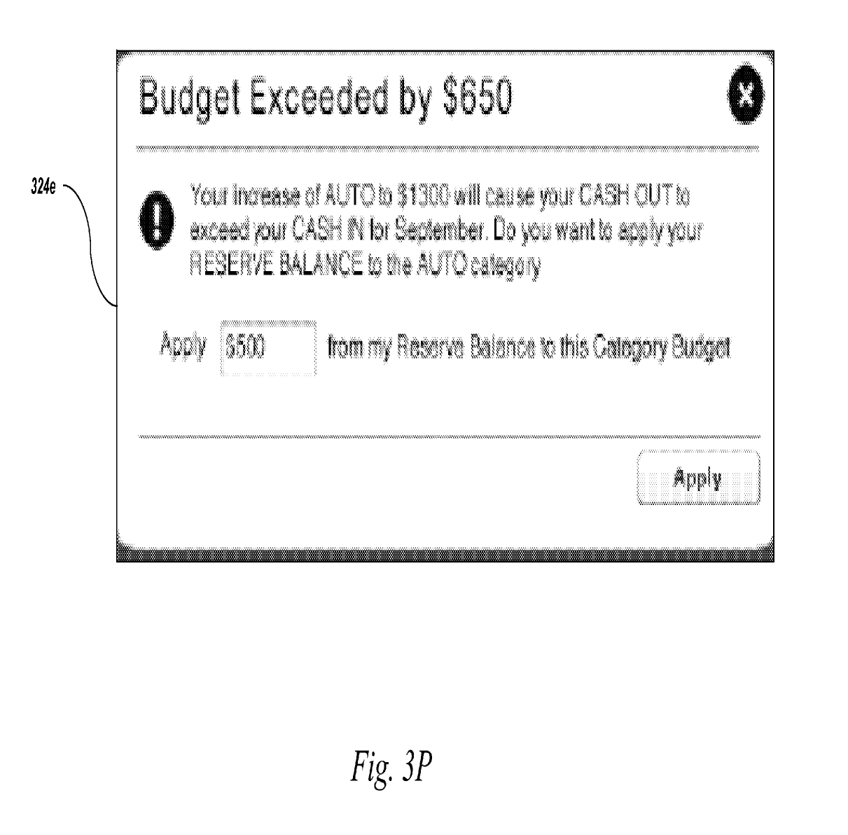

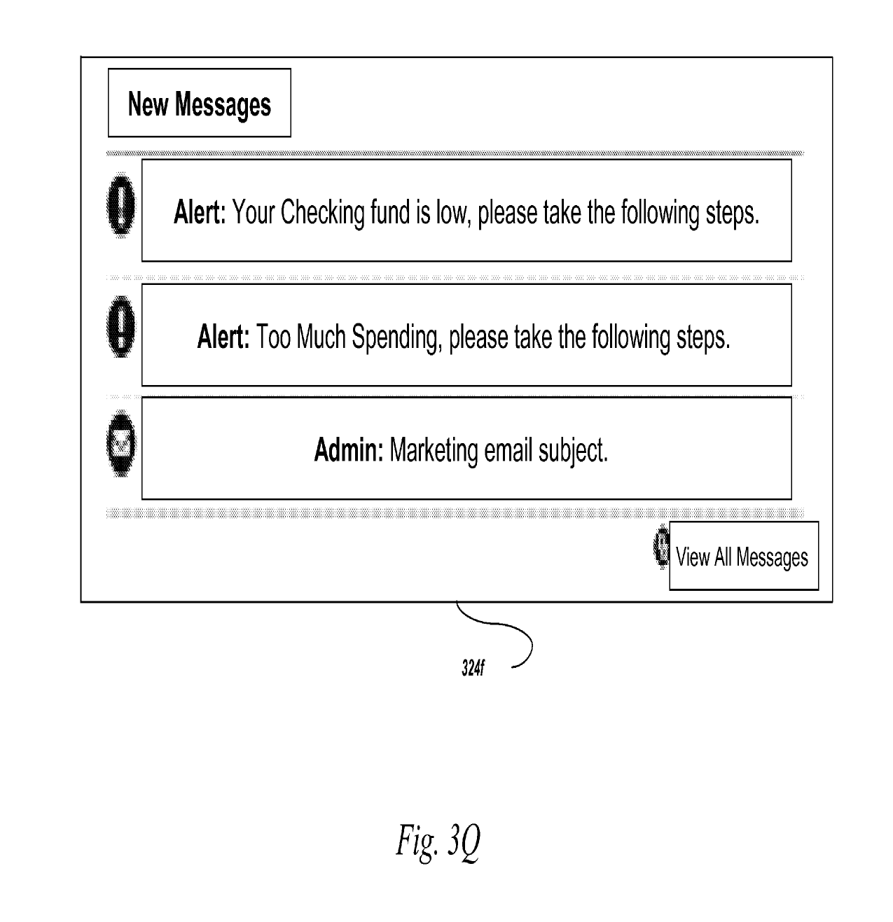

The user interface may present and provide access to the functionality, operations and services of the CFM. To implement the functionality of the CFM, the interface may include any number of user interface components generally referred to as widgets. A widget may comprise any one or more elements of a user interface which may be actionable or changeable by the user and/or which may convey information or content. Interface widgets may comprise any type and form of executable instructions that may be executable in one or more environments. Each widget may be designed and constructed to execute or operate in association with an application and/or within a web-page displayed by a browser. One or more widgets may operate together to form any element of the interface, such as a dashboard. The user interface may include any embodiments of the user interfaces described in FIGS. 3B-3R or any portions thereof or functionality provided such user interfaces.

In some embodiments, the CFM may include any type and form of database. The CFM may use one or more databases for storing, updating and/or managing any data received, processed, communicated by or traversing through the CFM. A CFM user or administrator may query the database, run reports or otherwise obtain data stored in the databases.

A household user may access the CFM and the user's CFM account through the user interface via any type and form of web browsers and/or applications that can connect to a network. In some embodiments, CFM account services are provided via a website or portal for online access. In some embodiments, Secure Sockets Layer (SSL) cryptographic protocol or Transport Layer Security (TLS) protocol is used by the CFM, portal or website to provide secure communications with web browsers, applications or devices used to access the CFM. Any type and form of security mechanisms and/or protocols may be used to provide a secure session or connection with the CFM, portal or website.

Via the user interface, a user may establish an account with the CFM. The account may include information identifying the household and/or members of the household. The account may include identifying and registering users of the household that may access the CFM. The CFM account may include a profile and preferences of the household or users from the household. The CFM account may include contact information for the household, including mobile device information, such as for text based communications.

The CFM account may include configuration or specification of information for any of the interfaces of the CFM. For example, the CFM account may include the specification of information for the financial interface to receive funds from one or more of the income sources. In another example, the CFM account may include the specification of information for a vendor interface to receive information from a corresponding interface. In another example, the CFM account may include the specification of information for a bill pay interface to pay bills on behalf of the household.

In some embodiments, the CFM account may itself be or include a banking or financial account as if the CFM is a financial institution. In some embodiments, the CFM account is an FDIC insured account. The CFM account may be established as a function of a partnership with a sponsor bank. In some embodiments, the CFM account may be a bank account of an entity operating the CFM. The CFM account may be a traditional checking account with unique banking related numbers for the account such as bank routing number and account number. In another embodiment, the CFM account may also include the identification and configuration of information regarding any third-party bank accounts, savings accounts, checking accounts, brokerage and/or investment accounts. In some embodiments, the CFM does not aggregate external accounts while in other embodiments, the CFM does aggregate external accounts. In some embodiments, the CFM provides a single account from which a user performs cash flow planning and execution in accordance with the CFM described herein.

In further details of FIG. 2B, a plurality of clients may access or use the CFM. For example, a client may be a certified financial planner or an accountant. Each certified financial planner or accountant may represent one or more households as clients. Similarly, one household member may represent one or more household members as clients. A financial planner, accountant, or household member may design and/or implement a cash flow management plan on behalf of a client. In some embodiments, a financial planner, accountant or household member may use a CFM to concurrently and/or independently implement, enforce, and monitor cash flow management plans for one or more clients. In some embodiments, a pay or spend recipient may interface with a client via a CFM. In other embodiments, a pay or spend recipient may interface directly with a client that uses a CFM to process information provided by the pay or spend recipient.

The CFM may include a cash flow optimizer 201 that determines current and/or future cash flow and makes recommendations or suggestions to change use, activity or allocation among any of the sub-accounts to meet a desired cash flow position. The cash flow optimizer may comprise any type and form of executable instructions executing on a device, such as a server. The executable instructions of the cash flow optimizer may be designed and constructed to perform any of the functions and operations of the cash flow optimizer described herein. Responsive to any activity via the CFM account, the cash flow optimizer may determine the current cash flow position and one or more future cash flow positions based on the cash flow management plan, such as planned spending, bill paying and savings. The cash flow optimizer may make such determinations responsive to events such as use of cash to pay a bill, use of cash for spending and/or use of cash for savings. The cash flow optimizer may make such determinations responsive to activity related to execution of or changes to the cash flow management plan, such as allocations among sub-accounts or changes in income to the account.

The cash flow optimizer may determine future cash flow positions according to cash flow management plan and current usage across the sub-accounts. The cash flow optimizer may determine the future cash flow positions over a timeline or at predetermined time periods, such as the next day, next week, next month, next quarter or any user specified time periods. The cash flow optimizer may determine the one or more temporal points in the future at which the cash flow position of the account becomes negative. The cash flow optimizer may determine the one or more temporal points in the future at which the cash flow position of the account becomes positive.

The cash flow optimizer may determine any corrective actions, recommendations on future cash flow use or changes to the cash flow management plant to bring a future negative cash flow position to positive, to maintain a cash flow positive position, to have the cash flow position meet a desired level or otherwise have the cash flow position correspond to the cash flow management plan. The cash flow optimizer may determine and identify for the account holder which bills to pay when to maintain a desired cash flow position. The cash flow optimizer may determine and identify what categories to spend in or not to spend in to maintain a desired cash flow position. The cash flow optimizer may determine and identify changes to savings goals to maintain a desired cash flow position. The cash flow optimizer may determine and identify changes to use of free cash or the reserved account to maintain a desired cash flow position. The cash flow optimizer may determine and identify changes to the configuration of the plans for any of the sub-accounts. The cash flow optimizer may determine and identify changes to the configuration of the cash flow management plan for one or more subsequent months.

The cash flow optimizer may be designed and constructed to determine, track and manage the cash flow position based on future free cash. The cash flow optimizer may determine the free cash available, positive or negative on any day in the future. The cash flow optimizer may determine the free cash available, positive or negative, in the future based on any event or activity in connection with the account, such as any planned pay or spend in accordance with the cash flow management plan. For example, the cash flow optimizer may determine the free cash available after a scheduled bill in the future is paid.

The cash flow optimizer may determine an action to cure a negative free cash position in the future. The cash flow optimizer may determine that one or more bills should be paid on a different scheduled date, and recommend what dates bills should be paid. The cash flow optimizer may determine a schedule for all bills to paid to optimize or maximize free cash. The cash flow optimizer may determine a schedule for all bills to paid to avoid negative free cash. The cash flow optimizer may determine limits on one or more categories for the spend sub-account to optimize free cash or to avoid a negative free cash. The cash flow optimizer may determine to apply amounts from a reserve account to optimize free cash or to avoid a negative free cash. The cash flow optimizer may determine changes to goals and/or the savings sub-account to optimize free cash or to avoid a negative free cash.

The cash flow optimizer may provide information on the cash flow positions of the CFM account via a user interface or dashboard. For the example, the cash flow optimizer may display a timeline of cash flow positions and use any type of coding or identifier to identify positive versus negative cash flow positions. Via the dashboard or user interface, the cash flow optimizer may enumerate a list of actions or recommendation to the cash flow management plan to meet a desired cash flow position. For each item in the list, the cash flow optimizer may identify and display the corresponding change to the cash flow position, such as amount of change and date of change. Via the dashboard or user interface, a user of the account may execute what if scenarios or select among a plurality of actions/recommendations to determine the effect on the cash flow position.

Referring now to FIG. 2C, embodiments of a system for cash flow management is depicted. In brief overview, the CFM 120 includes a CFM account 206 for each household to plan, execute and manage cash flow for the household using a plurality of sub-accounts pay 220, spend 230, save 240, and reserve 252. Each sub-account can be used to store, or virtually represent, the funds for all cash flow related activities within a category. The sub-accounts may represent a logical step or a visualization of cash flow. A sub-account may comprise a logical plan or allocation of cash flow within the CFM account. As such, in some embodiments, the sub-account is a data structure or object providing information on a break-down or allocation of the CFM account into these logical sub-accounts. Free cash 250 represents the funds remaining after cash flow has been directed to the pay, spend, and save sub-accounts. Free cash may be assigned, allocated to or represented by a free cash account. Portions of free cash may be allocated to, assigned or represented by a reserve sub-account. The household may allocate funds for bills, such as a mortgage, using the pay account 220. A household may use the pay plan element 220 to create a payment plan that contains information on the household's bills owed to a plurality of payees 224. The CFM may use payments element 226 to execute this plan by directing funds allocated in the pay sub-account 220 to payees 228. The household may allocate funds for expenses, such as groceries or gas, using the spend sub-account 230. The household may use the spend plan element 232 to establish an expense plan. The expenses element 236 can execute and enforce the plan by, for example, directing funds to categories 238 and monitoring the amount spent on each category. The household may save excess cash flow in the save sub-account 240. Using goals element 242, the household may plan specific savings goals by, e.g., identifying the name, total funds required, date by which the household would like to achieve the funding total and/or frequency of contribution to that goal. The CFM may display, via the user interface, the contribution amounts required and the household may agree to having the CFM create a purse for the goal. The CFM may automate fund transfers to the purse for the goal. The goals element 244 may be used to store, monitor, and disperse funds. At the end of a given time period, the remaining free cash 250, e.g., after all payments, expenses and savings have been made in the given time period, such as at the end of month, is swept into a reserve sub-account 252b. For example, at the end of each month any free cash remaining is swept into the CFM's reserve account which may be a cushion for unexpected or episodic expenses. The free cash may start over at the beginning of each month. The reserve sub-account 252b may be a back-up fund source for any unexpected or episodic expenses. In the event there is negative cash flow, the CFM may automatically direct free cash 250 previously stored in the reserve sub-account 252 toward a payment and/or expense. The household may direct free cash 250 to a purse element 252a. A household may use funds in the purse element 252a at any time for any purpose. A plurality of other elements may exist to direct funds in each sub-account pursuant to a household's plan.

In some embodiments, the CFM sub-accounts, elements, and categories, as used herein, may also represent a logical step or a visualization of cash flow. Funds for all sub-accounts and elements may be stored in a central CFM account instead of a plurality of sub-accounts. For example, the save sub-account may represent the amount of funds that have been allocated toward a specific savings goal, instead of a separate bank account containing funds. In this embodiment, the CFM may use the representations of the various sub-accounts, elements, and categories to plan, execute, and enforce a household's cash flow. Thus, transferring or directing funds to a sub-account or sub-element may represent a way of visualizing cash flow, and not refer to an actual transfer of funds from the CFM account to a sub-account.

The CFM may be implemented as one or more modules executing on one or more servers. The CFM may comprise an application, program, library, script, service, process, task or any type and form of executable instructions executing on a device, such as a server. The CFM may include client components and server components in a client-server architecture. The CFM, or a module or component thereof, may include functionality, operations or logic to implement any functionality of the CFM described herein. The CFM, or a module or component thereof, may include functionality, operations or logic to implement any of the pay, spend, and save accounts, or their sub-elements. The CFM, or a module or component thereof, may include functionality, operations or logic to implement any of the functionality to plan, execute and manage the pay, spend, save or reserve accounts, or their sub-elements.

The CFM contains a pay sub-account and related elements that allow the household to plan, pay, and monitor their bills. The pay sub-account 220 stores or represents the funds used to plan and pay a household's bills. In some embodiments, the pay sub-account may be a financial account within the CFM account. In other embodiments, the pay sub-account may be a separate account from the CFM account. In some embodiments, the pay sub-account may be an object, data structure or database entry representing fund allocation. In some embodiments, the household member may establish a pay plan and make payments using the pay plan element 220 and payments element 226 contained within the pay 220 sub-account. The pay plan element 222 and payments element 226 may include a plurality of interfaces, databases, software and algorithms running on a client or server. Using pay plan element 222, the household member may input one or more payees 224 for each household bill. The household may enter information regarding each bill. This information may include the payees name, account number, bill amount, due date etc. The due dates may be recurring indefinitely, or may be recurring for a fixed duration starting and ending at any time or based on any condition. For example, a car loan payment may be triggered once the household member has spent funds allocated toward a new car down payment. The payments element 226 may execute the pay plan by directing funds held in the pay sub-account 220 toward payees 228. In some embodiments, the payments element 226 may utilize the bill pay vendors interface 210 to make payments.

The spend sub-account 230 stores or represents the funds used to make a budget, enforce a budget and pay for household expenses. In one embodiment, the spend sub-account may be a financial account within the CFM account. In some embodiments, the spend sub-account is connected to a prepaid debit card, debit card or credit card. In yet another embodiment, the spend sub-account may be a separate account from the CFM account. In some embodiments, the spend sub-account may be an object, data structure or database entry representing spend plan or allocation. In some embodiments, the household member may establish a spend plan and pay for expenses via the spend plan element 234 and expenses element 236, respectively. The spend plan element 232 and expenses element 234 may include a plurality of interfaces, databases, software and algorithms running on a client or server. The spend plan may include a budget for a plurality of expense categories 234. In another embodiment, the spend sub-account may interface to a prepaid debit card, debit card or credit card. In some embodiments, the CFM may use the expenses element 236 to enforce the spend plan via the credit/prepaid debit card interface described above. For example, the CFM may provide the household member, via the interface, with a card that prohibits a user from spending more than $100 in the grocery category in a given time period, such as a given month.

The save sub-account 240 stores or maintains the funds used to plan and execute a household's savings goals. In some embodiments, the save sub-account may be a financial account within the CFM account. In other embodiments, the save sub-account may be a separate account from the CFM account. In some embodiments, the save sub-account may be an object, data structure or database entry representing the save plan or allocation. In some embodiments, the household member may establish a savings goal and allocate funds toward those goals via a Goals element 242. The goals element 242 may include a plurality of interfaces, databases, software and algorithms running on a client or server. In some embodiments, the household member uses the goals element to allocate funds toward savings goal categories 244. Each goal element 244 may represent a separate financial account within the save sub-account 240, or may be a database entry representing the fund allocation. In some embodiments, the CFM may automatically direct funds when a goal is met from the Save sub-account toward the Pay or Spend sub-account or sub-account elements, pursuant to the goal category 244. For example, a household member may use the Goals element 242 to set a $5,000 goal for a vacation. Upon reaching that goal, the CFM may automatically instruct the Spend sub-account and its sub-elements to create a budget category 234 for a vacation, and an expense category 238 to execute and enforce this expense. In another embodiment, the CFM may, upon reaching the saving goal, direct the funds to a purse within the reserve sub-account, as described below.

The free cash 250 element represents funds that are remaining after all funds for a given period have been directed toward payments, expenses, and savings goals. In some embodiments, the free cash element may be an object, data structure or database entry representing free cash, such as a free cash metric. In some embodiments, the household member may allocate free cash toward a Purse element 252a, Reserve element 252b, or pursuant to any other allocation defined by the user. The free cash sub-elements 252 may include a plurality of interfaces, databases, software and algorithms running on a client or server. In some embodiments, the purse element 252a may allocate funds to a credit or debit card that can be used anywhere at any time, with the only restriction being the fund amount. In some embodiments, the user may withdraw the funds in the purse via the debit card interface. In some embodiments, the household member may allocate funds in the purse toward any other element within the free cash sub-account, or the pay and spend sub-accounts. The reserve element 252b may intelligently compensate for a negative cash flow situation by directing funds to the pay or spend sub-accounts. The household member may define additional elements, e.g., investment element 252n, to direct free cash 250 in any manner and to any destination.

The CFM Account 206 may be a centralized account acting as the source of the household's finances and all information that may be necessary for the CFM 120 to function. The CFM account may contain historic, current and anticipated information regarding a household's recurring bills, expenses, savings goals, and free cash allocations. The Pay sub-account 220 may be used to budget 222 and then actually direct 226 funds to one or more Payees 224 and 226 accordingly. For example, household payees may be mortgagees, financial institutions, insurance institutions, telephone companies, internet service providers, cable television companies, and condominium associations.

The user may prioritize any of the sub-accounts and/or any items or categories within a sub-account. For example, the user may prioritize the Pay 220 sub-account over the Spend 230, Save 240, and Reserve 252 sub-accounts. The CFM Account 206 may also contain information regarding the priority of each Payee 224 & 226 in comparison to other Payees 224 & 226 or other sub-accounts 230, 240, 250. For example, a household's home mortgage payment may be given a high priority level, whereas a household's cable television payment may be given a lower priority. The Pay 220 sub-account will automatically direct funds to the Payees 226 in the order of their priority. Thus, in some embodiments, if the CFM Account 206 does not contain sufficient funds, and the household cannot input sufficient funds from their financial sources 202 or Save 240 and Reserve 252 sub-accounts, the Pay sub-account 220 may intelligently automatically direct funds towards household-critical Payees 226 in the order of their priority. The payments may be made via the Bill Pay Vendors Interface 210 described above.

The household user may use the CFM's Spend sub-account 230 to allocate and direct funds used for household expenses. These household expenses may be categorized 234 & 238. For example, categories 234 & 238 may include groceries, gas, clothes, entertainment, books, school supplies, repairs, maintenance, transportation, and gifts. The Spend 230 sub-account first allocates the money 232 according to a plan established by the user in the CFM account 206, and then provides a mechanism to pay for the expense 236. The expense may be paid 236 via credit card or a prepaid debit card that is linked to the CFM Account 206 via the Credit/Prepaid Debit Card Interface 212.

The CFM may be designed and constructed to track and/or enforce the use of cash according to the cash flow management plan. The CFM may issue or otherwise provide any type and form of financial card, such as a debit, prepaid or credit card that is associated with, linked to, managed by or otherwise used in conjunction with the household account maintained by the CFM for a household. In some perspectives, the financial card is a wrapper or wraps around the CFM household account, As such, in some embodiments, the financial card is a primary financial access means to the CFM household account. In some embodiments, the financial card is the only financial access means to the CFM household account. In this manner and in some of these embodiments, the financial card in combination with the CFM provides controlled access to the CFM for tracking and enforcement purposes. The CFM system may load or deduct amounts to/from the financial card in accordance with configuration execution of the cash flow management plan. The CFM system may load or deduct amounts to/from the financial card on a predetermined frequency or schedule in accordance with configuration execution of the cash flow management plan. The CFM system may load or deduct amounts to/from the financial card responsive to rules or policies set via the CFM in accordance with configuration execution of the cash flow management plan.

In some embodiments, the CFM and/or Spend sub-account 230 may automatically load a prepaid debit card, via interface 212, based on the amount of available funds in the CFM Account 206, a Spend Plan 232, Category 234, and/or a priority level for the expense. In some embodiments, the CFM may automatically load a mobile payment account based on the amount of available funds in the CFM Account 206, a Spend Plan 232, Category 234, and/or a priority level for the expense. The CFM may then enforce this spend plan 232 by only authorizing one or more vendors to deduct funds from the prepaid debit card based on whether that vendor sells items falling within a Category 234. This information may be provided by the Vendor Interface 208 in real-time or may be based on a user-defined class of vendors. For example, a household may plan to spend $100 per week on groceries and may exclusively purchase groceries from Whole Foods, Trader Joes, and Star Market. Based on this information, the CFM may provide the household with a prepaid debit card that is only capable of being used at Whole Foods, Trader Joes, and Star Market. In another embodiment, the CFM may limit the amount of funds on the prepaid debit card to $100 per week. The CFM may automatically reload the debit card at the beginning of each week.

In another embodiment, the CFM may enforce the spend plan 232 by automatically limiting the purchases made by the credit or prepaid debit card to only those items that fall within Category 234. The CFM may, in real-time, grant or deny authority to the debit or credit card based on the category or type of purchase. In some embodiments, the CFM may grant or deny authority to the debit or credit card based on UPC information received via a Vendor Interface 208. For example, if the household shops at BJ's Wholesale Club, which sells groceries, household supplies, clothes, school supplies, and conducts automotive repairs, then it may be beneficial for the CFM to automatically grant or deny authorization on a per item basis. In some embodiments, this information may be provided to the CFM via the financial data interface 208 in real-time. In some embodiments, this information may be provided by the credit/prepaid debit card interface 212.

If there are remaining funds in the CFM Account 206 after the CFM automatically directs cash flow to the Pay 220 and Spend 230 sub-accounts, the remaining funds can be allocated to the Save 240 sub-account based on the household's financial goals 244. A household may define one or more financial goals 244 for specific events or purposes, e.g., a vacation 244a and a new car 244b. The financial goal 244 may be a one-time monetary amount, e.g., a vacation, or a monthly recurring expense, e.g., a new car loan. If the financial goal is a recurring monthly payment for a fixed period of time, the Save subaccount 240 may intelligently allocate funds and also predict, based on current and projected cash flow directed towards the Pay 220 and Spend 230 sub-accounts, when the financial goal may be realized. For example, a new car loan may require a financial goal of $300 per month for five years. Based on the current and projected cash flow, the CFM may calculate that the household can only afford $250 per month for five years, which is short by $50 per month for five years, or $3000. Thus, in some embodiments, the CFM may automatically direct remaining funds to the New Car Goal 244b within the Save sub-account 240 until it is possible for the household to pay $300 per month for five years. In this example, once $3000 has been allocated toward the New Car Goal 244b, the CFM will automatically notify the household, via the User Interface 216, that they can afford to get a new car loan for $300 per month for five years. That is, the household has $250 of excess cash flow each month after all funds have been directed toward the Pay 220 and Spend 230 sub-accounts, and the remaining $50 per month may be withdrawn from the New Car Goal 244b sub-account. This may help a household set realistic financial goals and realize those goals, without adversely impacting any other payments or expenses. In another embodiment, the CFM may cross-sell a plurality of financial services tailored to the user. For example, the CFM may provide the user with a mortgage plan that is tailored to the cash flow plan set by the user. The financial services may be provided by the CFM or any other entity.

Still referring to FIG. 2C, embodiments of the Cash Flow Management System 120 may automatically direct free cash 250, e.g., remaining cash flow that has not been directed toward the Pay 220, Spend 230, and Save 240 sub-accounts, toward a Reserve sub-account 250. The household may allocate free cash 250 toward the one or more sub-accounts 252, including a purse 252a, reserve 252b, and an investment 252n. The household may be able to use funds in a purse 252a anytime and in any manner. The CFM may automatically withdraw funds from the reserve sub-account 252a to meet the necessary Pay 220 and Spend 230 cash flow output when the input from financial sources 202 is not sufficient.

In one embodiment, the CFM may direct all free cash toward the reserve sub-account, where the funds are used to provide a cushion in the event of an emergency or any other imminent financial burden. In some embodiments, the user may define a reserve goal. For example, if the user sets a reserve goal of $1000, the CFM may continue to direct all free cash toward the reserve account until the reserve goal has been met. Thereafter, the user may direct free cash to a purse, savings goal, or any other sub-account. In another embodiment, the CFM may automatically determine an optimal reserve goal based on the cash flow of a household. For example, the CFM may set the reserve goal to be a multiple of the expenses of a household for a month. In this example, a $6000 reserve goal would provide a household with monthly expenses of $2000 with a three month cushion. The CFM may automatically update the reserve goal based on monthly expenses, anticipated monthly expenses, average monthly expenses, etc.

In another embodiment, the CFM may be able to automatically optimize where free cash is directed. For example, the CFM may automatically determine whether funds should be directed towards the pay sub-account or an investment sub-account based on current cash flow data. The CFM may direct free cash to certain accounts or in a certain manner based on user configuration or user rules regarding the same.

In another embodiment, the CFM may optimize cash flow and savings by automatically directing funds to a plurality of sub-accounts in accordance with an optimization algorithm. For example, the CFM may be determine, using data from a plurality of interfaces, that a linked investment account may provide the best return on investment for the CFM user. In another example, the CFM may predict a negative cash flow situation in the future and, accordingly, direct free cash to the reserve sub-account. In some embodiments, the CFM may help a user reach a financial goal sooner. For example, the CFM may determine, using data from a plurality of interfaces, that the price of a plane ticket for a vacation is continuously increasing, whereas the price of a new computer is decreasing. Using this data, the CFM may automatically direct a larger portion of free cash toward the vacation savings goal so the user may first purchase the plane ticket. Thereafter, the CFM may automatically direct remaining free cash toward the new computer savings goal. In this example, the CFM saved the user $100 off the price of a plane ticket by allowing the user to purchase it one month sooner, and another $100 off the price of a new computer by preventing the user from purchasing it for one month. In another embodiment, the CFM may optimize cash flow by directing funds in accordance with a priority level set by the user.

Embodiments of the cash flow management system 120 may include any combination of the features described herein. With these embodiments of the cash flow management system, the present solution provides planning, control, enforcement, automation, algorithms and monitoring not previously offered in a single integrated solution and service as presented herein. Embodiments of the cash flow management system may be offered, delivered or deployed as a Software As A Service or a managed service, application or platform. Embodiments of the cash flow management system may be offered, delivered or deployed as an outsourced service. In some embodiments, the cash flow management system may be offered, delivered or deployed as a combination of managed and outsourced service. In yet another embodiment, the cash flow management system may be sold or licensed as a white label product or service that another entity may market or rebrand as their own.

Referring now to FIG. 3A, a diagram of an embodiment of a method of using embodiments of the Cash Flow Management system is depicted. In brief overview, at step 302, a household member accesses the CFM via user interface. At step 304, the household member may establish an account. The household member may create an income plan at step 306 by providing information regarding financial sources. At step 308, the household member may provide information regarding their bills to create a payment budget plan. At step 310, the household member may create a spending budget plan. The household member may use exemplary spending budgets provided at step 328 to assist them with creating a spending budget plan. At step 312, the household member may create a customized savings plan for specific goals. The household member may use exemplary savings plans provided at step 328 to assist them with creating a savings plan. At step 314, the CFM may present a cash flow forecast using information provided by some or all the steps in this figure. At step 316, the CFM may acquire funds from financial sources provided at step 306 income plan, or from any other financial source. The CFM may make payments at step 318 pursuant to the payment plan created at step 308, or otherwise directed. At step 320, the CFM may enforce a spending budget plan created at step 310. The savings plan created at step 312 may be implemented at step 322 by allocating funds to specific savings goals. At step 324, the household member may monitor account balance across any sub-account via the user interface.

In further details of step 302, any household member or user accesses the CFM to request an account with the CFM. The household member may establish an account by inputting their relevant information via a User Interface 216, including but not limited to their name, address, phone number, social security number, date of birth, and email address. The user may also create a unique username and password that will grant them access to this account. The user may enter any of these information, constraint(s) and/or goal(s) using a form, script and/or command line submission. The user may provide any of this information and/or selection via a web or application interface. For example, the user may input their information via a user interface as shown in FIG. 3B.

At step 304, the CFM may verify or authenticate the account or the household or person associated with the account. The CFM may run an authentication routine to verify that the information entered is accurate. For example, the authentication routine may compare the inputted family name and the address with a publicly available assessor's database containing real estate property addresses and their owners. In another embodiment, the authentication routine may compare the inputted family name and address with the United States Postal Service database. In yet another embodiment, the authentication routine may require the household member to submit a current utility bill containing the household member's name and address. This utility bill may be submitted electronically or physically mailed to the relevant address. In some embodiments, the CFM may interface with a third-party that performs the authentication.

At step 306, a household user may setup income or funding to their account for the cash flow management system. The user may input information regarding all their financial sources 202. In one embodiment, as shown in FIG. 3C, the information the user may input, via a User Interface 216, includes their monthly income, frequency of deposit, amount of deposit, and type of deposit. Types of deposits may include direct deposit, PayPal, ACH, Remote Deposit Capture, a Reload Network or any other mechanism capable of transferring or depositing funds into a CFM account 206. In some embodiments, the user may be required to complete a form, either online or after downloading and printing, and submit the form to the Human Resources department where the user works or any other relevant party responsible for setting up a direct deposit payment plan. The form may be submitted either electronically or by sending the completed physical form.

At step 308, the household user may set up a pay sub-account. In this phase, the household user inputs, via the User Interface 216, the bills that need to be paid on a one time or recurring basis, or paid during a certain time period in the future. The bill amounts and frequency may be fixed or variable, and may be entered by the household user or automatically provided to the CFM via the Vendor Interface 208 or the Bill Pay Vendors Interface 210. For example, as shown in FIG. 3D, the household user may have one or more bills, including a mortgage, utilities, car loan, and insurance. In another embodiment, the household user may simply enter their account information and the bill payee's information and command the CFM to utilize its bill pay vendors interface 210 or financial data interface 208 to automatically determine the due date and amount of each bill on an ongoing basis. The CFM may make this determination by downloading the information from the appropriate interfaces 210 and 208, or by predicting, based on previous bills, the amount and due date of future bills.

In another embodiment, the CFM may assist the user in setting up the Payment Plan 308 by suggesting typical categories of bills a household pays, including mortgage, rent, car payments, insurance, utilities, cable television, telephone, and internet. In yet another embodiment, the CFM may automatically use information about the household, including their geographical location, family size and children's ages, and income amount to further suggest bill categories or even specific payees. For example, the information may contain the user's address, and the CFM may determine, using interfaces 208 or 210, that there is only one cable television provider for that address. This information may include information entered by the household user when they established an account 304, or the information may be gathered from the computing device's IP address or global positioning system, or the information may be gathered using various data mining techniques known in the art.

At step 310, the household user may create a Spending Budget Plan 310. The spending budget plan 310 may have a plurality of categories, including auto, home, dining shopping, other, and the user may enter additional categories via User Interface 216, as shown in FIG. 3F. For each spending category, the user may allocate or designate a predetermined amount of funds. For each spending category, the user may allocate a predetermined amount of funds to each of a plurality of users for that category. For example, the user may allocate first amount for a first category for a first household member and a second amount for the first category for a second household member.

At step 328, the CFM may suggest savings categories using information about the household, other users of CFM, or information gathered through any of the CFM interfaces 208, 210, 212, and 216. The CFM may determine categories to suggest at step 328 by applying data mining techniques to information gathered from the World Wide Web via the financial data interface 208. The CFM may also suggest spending amounts for each of those categories. In one embodiment, the CFM may provide a statistical analysis of the amount based on income level, family size, and other relevant factors. For example, the CFM may analyze all its users to determine that a family of four spends, on average, $100 per week on groceries, with a range of $50 to $300. The CFM may update these values using information accrued on the household thus far. In another embodiment, the CFM may cross-sell other products or services by recommending products or services a user can set a savings goal for.

In another embodiment, the CFM may apply a smoothing function to all the expenses that mitigates payment or expense fluctuation from month-to-month. The CFM may use any data retrieved from a plurality of interfaces to drive this smoothing function. For example, the CFM may use historic expenditures to project all future expenses for the next twelve months, and then evenly distribute those expenses over twelve months. In this example, the CFM may reduce any fluctuations due to winter heating bills and/or summer electricity billings. In another embodiment, a CFM user may only receive income for a part of the year, or much less income during a part of the year. The CFM may, via the smoothing function, evenly distribute this income over twelve months, thereby mitigating any income fluctuations. In both cases, the CFM may provide the user with increased financial predictability and stability.

In addition to creating the Spending Budget Plan at 310, the household user may request, direct or command the CFM to automatically enforce the spending budget plan at step 320. Embodiments of this were discussed above, and will be discussed further in conjunction with step 320, enforce Spending Budget and FIG. 3F. For example, the CFM may enforce the spending budget via prepaid cards and/or via authorization of purchase of items via a card on a category basis. In another embodiment, the CFM may enforce the spending budget on a credit card via spending caps placed on merchant category codes (“MCC”), e.g., dining.

At step 312, the household member may create a Savings Plan. The household user may add one or more Savings Goals through a user interface, as mentioned above. In one embodiment, as shown in FIG. 3G, the user may input a goal title and an icon that symbolizes that goal. The user may also choose to select a savings method, as previously discussed. Methods for saving may include by target date and by target amount. The user may elect to make a one time or recurring transfer of funds from the CFM Account 206 to the Savings account 240 for the specific savings goal 244, as shown in FIG. 2C. In another embodiment, the amount to transfer to a savings goal 244 can be based on a percentage of the total amount of funds remaining after all the bills and expenses have been paid for a relevant time period.

At step 314, the CFM may present, via the user interface, a Cash Flow Forecast or Future Balance. The Cash Flow Forecast may present, in a holistic manner, how one or more of the household's income plan, payment plan, spending budget plan, and savings plan will affect the household's cash flow. In one embodiment, FIG. 3I, the cash flow forecast may show previous and future CFM Account 206 balances on a daily, weekly, monthly, or yearly basis, or based on any other time period. For example, the time period may be based on when the household plans to receive funds or make payments, or whenever there is a change in the account balance over a certain amount.

In another embodiment, the Cash Flow Forecast at step 314 may present to the user, via a user interface, a snapshot of the planned and actual budget and cash flow for a given month at a given time. For example, in FIG. 3I, the Cash Flow Forecast shows the portion of planned income that has actually been transferred to the CFM Account 206. In one embodiment, this forecast may graphically be represented as a glass tank being filled by a liquid, where the tank represents the total amount of cash flow or budget for that account, and the liquid fill level represents the amount of cash flow or cash in completed as of a certain date or time. The Cash Flow Forecast may similarly present the budget status of the Pay 220, Spend 230, Save 240, and Reserve 252 sub-accounts and free cash 250. The status may include, but is not limited to, one or more of the following: the amount of funds that have been planned at a given point in time and allocated to that account, the amount of funds planned at a given point in time and already paid or spent or transferred from the account, and the amount of funds that were planned at a given point in time and are remaining to be dispersed from that account within a given time period.

Another embodiment of the Cash Flow Forecast at step 314 may be in the form of a bar graph. For example, FIG. 3J presents, via a user interface, the global budget plan for a given month. The global budget plan may include the holistic budget status to date as well as the budget to date for each account: Income, Pay, Spend, Save, and Reserve, as described above.

In yet another embodiment, the Cash Flow Forecast at step 314 may be a hypothetical cash flow based on one or more steps: Income Plan 306, Payment Plan 308, Spending Budget Plan 310, and Savings Plan 312. For example, FIG. 3K presents, via a user interface, the hypothetical cash flow with planned changes. The impact of the planned changes on a given account may be presented in a different color, font, size, or in any other manner that may notify the user of a change to one or more account. Any embodiment of the Cash Flow Forecast at step 314 may also be used by the household to Monitor the Account Balance at step 324, as will be further described later.

At step 316, the CFM may acquire funds from one or more of the financial sources 202 discussed previously. The funds may be acquired pursuant to an Income Plan established at step 306, or may be otherwise transferred to the CFM as the user directs. These funds may be stored in the CFM Account 206.

Provided there are sufficient funds in the CFM Account 206, the CFM may then Make Payments at step 318 pursuant to the established Payment Plan at 308. Payments at this step may be made via the Bill Pay Vendors Interface 210. The CFM may make all or part of the payments entered into the Pay Plan 222 during the Payment Plan step 308. The CFM may make each payment when the payment is due, when sufficient funds exist to make the payment, or pursuant to any other condition set by the household member. For example, the household member may instruct the CFM to make payments in full according to their priority. That is, if a mortgage payment was prioritized over a cable television bill, and the user instructed the CFM to make payments as sufficient funds existed, the CFM would not pay the cable television bill until the mortgage was paid in full.

At step 320, the CFM may enforce the Spending Budget created at 310. In one embodiment, the household user may command the CFM to actively enforce the planned spending budget 232 as inputted by the user during the Spending Budget Plan 310 step. For example, FIG. 3F may represent a user interface wherein the household user may selectively turn on and off active enforcement of spending budgets for a specific category 234a-n or the entire Spend sub-account 230. If the household enables active enforcement, the CFM may use one or more methods and systems, described above, to prevent the household user from exceeding their monthly budget. In some embodiments, this enforcement may include providing the household member with a prepaid debit card that can only be used pursuant to the spending plan. The CFM may reload the prepaid debit card at step 320 pursuant to a spending plan established at step 310. In some embodiments, the enforce spending budget step may involve receiving real-time information regarding purchases through one or more CFM interfaces in order to control cash flow. For example, the CFM may deny a credit card authorization request from a restaurant if the purchase price exceeds the amount allocated for dining. In another embodiment, the CFM may grant or deny based on individual items being purchased.

At step 322, the CFM may implement the savings plan established at step 312. In one embodiment, the CFM may automatically allocate all remaining funds pursuant to the savings plan 312 and transfer the funds into the Save sub-account 240 or the sub-account for a savings goal 244a-n. In yet another embodiment, the CFM may direct a portion of the funds to the savings sub-account 240, and direct a portion of the funds to the Reserve 250 sub-account. For example, if the cash in for a certain period exceeds the amount of cash out, the CFM may direct funds to a Reserve sub-account 250, as previously described. The CFM may direct these funds at step 322 at any time. In some embodiments, the CFM may implement the savings plan when funds are remaining after all payments and expenses for a given time period are made. The time period may be linked to when the CFM acquires funds, e.g., recurring direct deposit of a paycheck, or may be weekly or monthly or any other time period. In some embodiments, the CFM may intelligently forecast the cash flow for a defined period, and only allocate savings when there will be excess cash flow at the end of that user defined period.

At step 324, the household user may dynamically monitor the account balance across all sub-accounts or observe their cash flow. The household user may use this information to address issues with cash flow by entering one or more other steps previously described. The CFM may provide information regarding the CFM account and sub-accounts, and may also incorporate information received through a plurality of interfaces. For example, a user's sub-account 250 may be linked to an investment account 252n with a third party financial institution. In this example, the CFM may receive, via the Financial Data Interface 208, detailed information regarding the user's stock portfolio, such as its current value, year-to-date change, or any other information the CFM may infer from the data provided through the financial data interface 208 or the financial interface 204.

In some embodiments, the CFM platform may provide comprehensive reporting capabilities. Reporting capabilities include support for internal clients (e.g., CFM administrators and developers) as well as external client (e.g., household users). Reporting may be provided via the CFM user interface and/or delivered directly to a requestor, e.g., via email. Reporting capabilities include operational reporting as well as any type or form of insight and analytics. In some embodiments, operational reporting includes any type or form of statistics, logs, records, summaries and/or alerts pertaining to the operation of the CFM system or cash flow status. Insights and analytics may include any type or form of information or data processed or derived from operational data, vendors, financial institutions, and/or third-party sources. The CFM system can provide real-time analytics, e.g., via a feedback loop in which the CFM monitoring or forecast modules constantly updates based on any change in cash flow or account balance.

FIGS. 3L, 3M, 3N, 3O, 3P, and 3Q are exemplary reports generated by the CFM system at step 324, Monitor Account Balance. Reports may be in the form of a bar graph or a pie chart or any other graphical form, e.g., FIGS. 3M & 3N. In addition, a report may be in the form of an alert or notification to the household user via the user interface, e.g., FIG. 3P, or email, text message, voicemail or any other mode of communication through network 104. This report may be generated due to a specific condition, e.g., “Budget Exceeded” as shown in FIG. 3P. Multiple alerts can be reported together on a daily, weekly, or monthly basis, or with any other frequency set by the user. For example, FIG. 3Q shows a report with three alerts together via the user interface.

In one embodiment, a household member may also monitor another person's cash flow. For example, a first user may grant permission to a second user to monitor the first user's account balance. The CFM may permit the first user to grant second user different levels of permission. For example, the first user may permit the second user to only observe cash flow, but not to make any changes to first user's plans or sub-accounts. The first user may also permit the second user to observe only specific sub-accounts, or make changes to specific plans. This embodiment may be beneficial to a household that gains financial advice or assistance from a third-party, e.g., a financial advisor or accountant.

This embodiment may also be beneficial if there are multiple users in the same household. For example, the primary household user may establish a CFM account with an income plan, payment plan, and spending budget plan. If the cash flow input exceeds the cash flow output, the CFM may automatically direct the excess funds, e.g., free cash 250, to a reserve sub-account 252. The primary household user may direct all or a portion of free cash 250 to a second household member, such as a dependent child. In one embodiment, this second household member may have their own CFM account, which would consider these funds as income from a financial source 202 and enter their CFM account 206. In another embodiment, the primary household member may grant the second household member permission to add only savings goals 244 to the primary CFM Account. In yet another embodiment, the primary household member may grant the second household member permission to only add savings goals 244 that meet a certain user defined criteria. These criteria may, for example, limit the amount of the savings goal 244 to $100 or a percentage of the cash flow, limit the duration of the goal to one month, limit the time period for when goals can be set, or limit the savings goals categories.

The CFM steps may be performed in the order shown in FIG. 3A, or any other order. Steps may be taken individually or together with other steps. For example, a minor household user may establish an account at step 304, income plan at step 306, and a savings plan at step 312. In this example, the CFM may proceed to the Cash Flow Forecast at step 314 step and then skip to the Implement Savings Plan step 322, and the household user may frequently enter the CFM's Monitor Account Balance at step 324. Thus, the CFM system and methods may be tailored to suit any user at any phase of cash flow management.

FIG. 3B is an exemplary embodiment for establishing a CFM account via a user interface. In this embodiment, the household member may input their name, address, gender, phone number, email address, verify their email address, social security number and date of birth. The CFM may provide a way for the user to read and agree to their terms and conditions. In some embodiments, the CFM may notify the use of required certain fields by displaying an asterisk adjacent to the field's title, and preventing a user from selecting the “Enroll” button until all necessary fields are complete.

FIG. 3C is an exemplary embodiment of the account setup via user interface. In this embodiment, the user may input via forms and pull-down menus, information regarding their monthly income, such as the income source title, amount of monthly income, frequency, and type of income source. In this embodiment, the user may be able to complete and download a direct deposit form via this user interface. The user may use this embodiment to select other ways to fund the account from a list possible funding sources.

FIG. 3D is an exemplary embodiment of a user interface for setting up a payment plan, as previously described. This embodiment groups payees by category, and provides the user with the ability to edit, remove, or add payees within each category.

FIG. 3E is an exemplary embodiment of a user interface for setting up a monthly spend budget. In this embodiment, the user interface presents a plurality of categories of expenses, and allows the user to vary the expense amount per category via enter a number into a form, or via manipulating a sliding scale. The household member may add or remove budget categories via this user interface. The user may also use this embodiment of setting up a spend plan to setup a CFM Card. This card may be a credit or prepaid debit card and operate as described above.

FIG. 3F is an exemplary embodiment for activating the budget enforcement element of the CFM via a user interface. In this embodiment, the CFM provides the user with a pop-up window that has a description of the spending limit and the result of activating the enforcement element. The user may activate the budget enforcement by selecting the “I agree” box and then clicking on continue. The user may, on the other hand, choose not to activate the budget enforcement by not selecting the “I agree” box or by closing the window via the “X”.

FIG. 3G is an exemplary embodiment of adding a savings goal via a user interface. The window provides the user with information on what a savings goal and how the goal can be used. The user may then, via the user interface, input a goal title, goal icon, savings method, date, goal total, frequency, and transfer amount/pay. The user may choose not to enter a savings goal by closing the window by selecting the “X”. If the user fails to enter all the information before selecting “continue,” the CFM may ask the user to return to the form and complete the information, or may provide an exemplary form using information gathered through various CFM interfaces or previous savings goals.

FIG. 3H is an exemplary embodiment of a user interface presenting the savings goals and status. In this embodiment, the goal information includes the goal title, goal icon, monthly contribution, and the total goal amount. The goal status includes the amount of funds allocated to that goal thus far, percentage complete, and the number of months to completion. The user may, via this interface, transfer funds toward a savings goal by selecting “transfer now”. The user may, via this interface, start the process of setting up a new savings goal by selecting “setup recurring transfer”. The user may select “setup reminder” to instruct the CFM to send a reminder, via the user interface, when certain conditions are met.

In some embodiments, as shown in FIG. 3H, the CFM sub-accounts and functions may be presented, via a user interface, as separate tabs running horizontally across a graphical user interface. The user may select these tabs to perform one or more functions. In some embodiments, the CFM may present the Cash Summary on a portion of the window. This cash summary may include a holistic snapshot of the income funds, account balance in the pay, spend, save and reserve sub-accounts, and a summary of savings goals. In some embodiments, the CFM may provide tips to the user that may facilitate their use of the CFM system or help them achieve cash flow success. In some embodiments, this information may remain on a portion of the window when a user switches from one sub-account or function panels.

FIG. 3I is an exemplary embodiment of a user interface for a cash flow forecast, as described above. The user may view a forecast for past, current, and future cash flow via manipulating the user interface. The CFM may provide, via this user interface, detailed cash flow information for any month. The CFM may use actual cash flow data to calculate cash flow for any time period up to the present. The CFM may use only planned cash flow allocations to calculate a cash flow forecast for any time period in the future. This information may include the planned cash in, and the amount received and the amount yet to be received to date. The CFM may provide information on allocation of funds across pay, spend and save sub-accounts. For the pay sub-account, the CFM may present the amount of funds that have not been received yet, the amount paid, and the amount remaining. For the spend sub-account, the CFM may present the amount of funds that have been received yet, the amount spent, and the amount remaining. In some embodiments, the CFM may present a demarcation in the Spend sub-account user interface that represents overspending. The save sub-account user interface, as shown in this embodiment of a user interface, provides information on the amount of funds that have yet to be received and the amount of funds transferred toward savings goals.

FIG. 3J is an exemplary embodiment of a user interface for presenting the global budget plan for a selected month. In this embodiment, a horizontal bar is filled using a plurality of colors to represent the budgeted funds to date, the actual funds to date, the monthly budget, and the projected budget. The fill level corresponds to the amount, which is numerically presented adjacent to the fill line. In this embodiment, the cash in, pay, spend, and save sub-account statuses are presented by a horizontal bar graph. The CFM numerically displays the current and total amounts for each category.

In some embodiments, the “in month” budget plan (e.g., the current month) shows total cash in and out as planned to actual. In some embodiments, the “future” month budget plans shows only planned pay, spend and save allocations as there is no cash yet.

FIG. 3K is an exemplary embodiment of a user interface for displaying a hypothetical cash flow with planned changes. The user may, at any time prior to or after making an actual change, choose to view the impact any financial change may have on their cash flow. FIG. 3K is an illustration of a high-level summary of the hypothetical cash flow based on a planned change. This illustration uses the color orange to highlight the affect the planned cash flow change has on Income, Spend, and Free Cash. The pay and save sub-accounts, which are not affected, are displayed using the color white. Furthermore, this illustration displays the entire cash flow as a convenient, easy to understand equation. According to the equation, free cash represents the funds that are remaining after all payments, expenses, and savings have been subtracted from the income.

FIG. 3L is an exemplary embodiment of a user interface for displaying and monitoring the cash summary, as previously described.

FIG. 3M is an exemplary embodiment of a user interface for displaying and monitoring the spending budget for a selected month, as previously described. The user may add or remove spending categories from this user interface.

The pie chart shown in FIG. 3N is an exemplary embodiment of a user interface for comparing the amount of cash flow that is allocated or directed to the pay, spend, and save-sub accounts.

FIG. 3O is an exemplary embodiment of a user interface for displaying the status of the cash in, pay, spend, save and reserve sub-accounts.

FIG. 3P is an exemplary embodiment of a user interface that notifies a household member of when their spending or payments will exceed their budget and result in negative cash flow. The household member may use this user interface to allocate funds from their reserve sub-account toward a specific category. The household member may also use the information provided by this notification to return to adjust their pay, spend, or save plans to prevent a negative cash flow situation.

FIG. 3Q is an exemplary embodiment of a user interface that displays a plurality of messages to the household member. This embodiment includes alerts related to cash flow, as well as administrative announcements related to market. This embodiment may provide the household user with any other notification, announcement or alert.

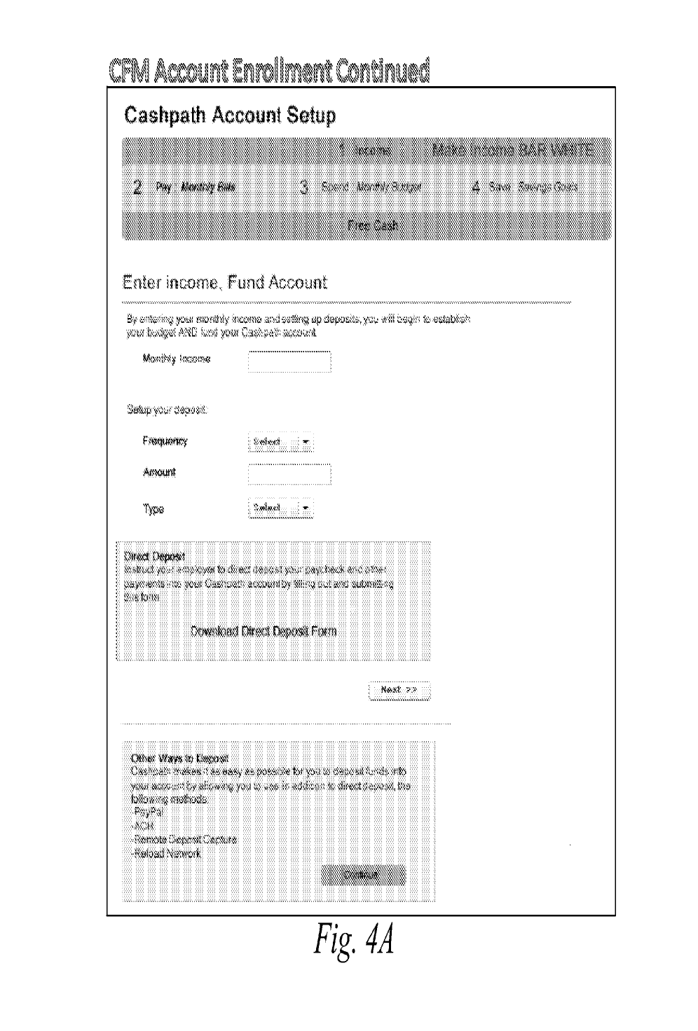

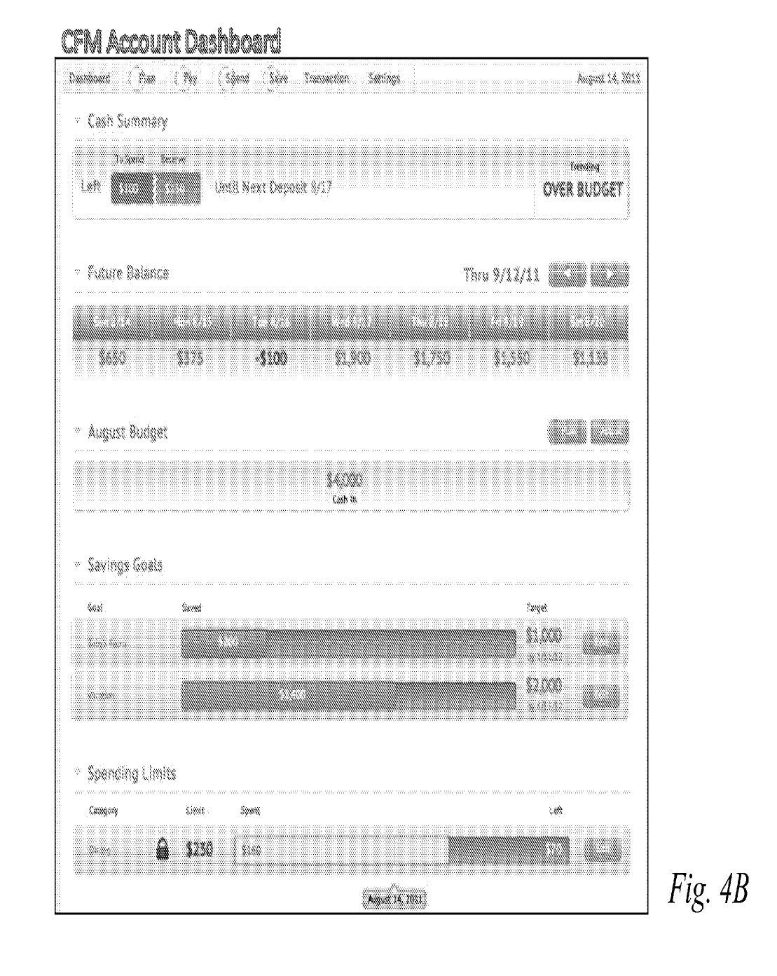

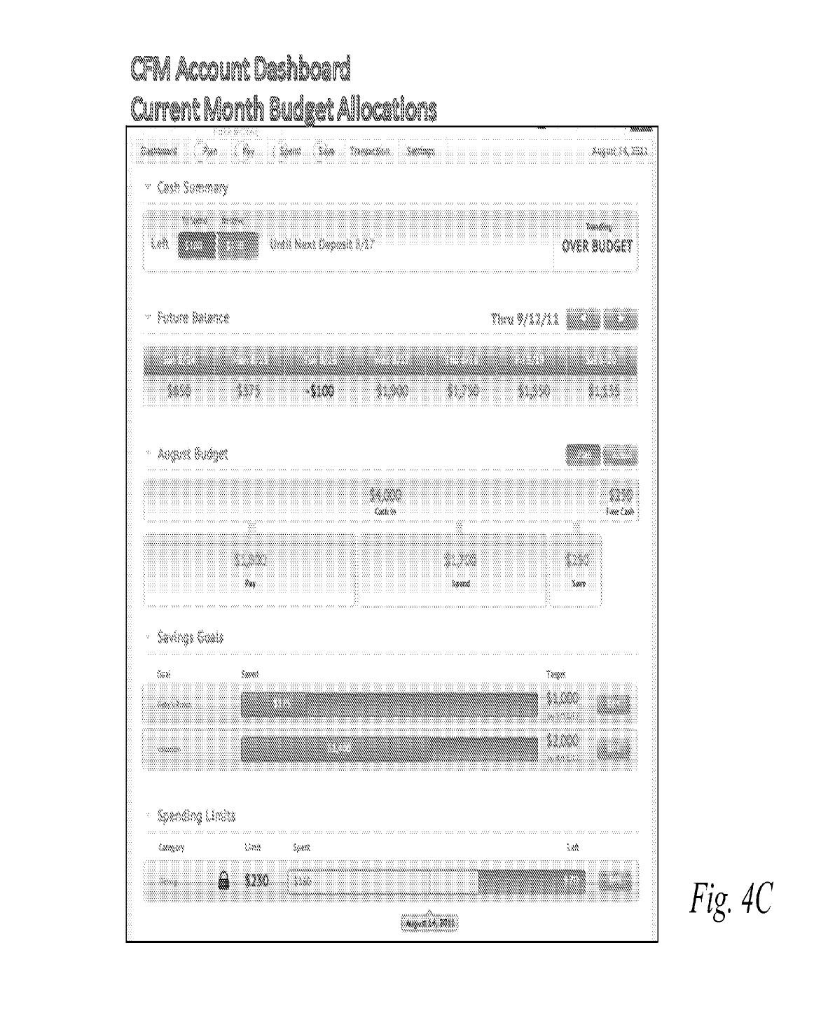

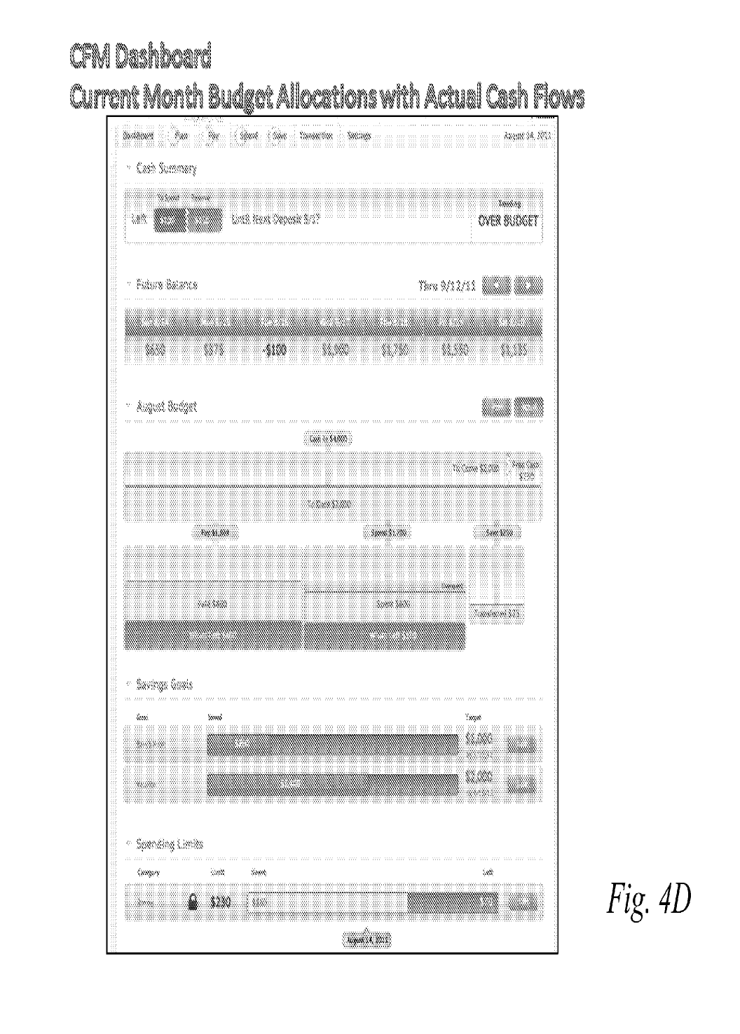

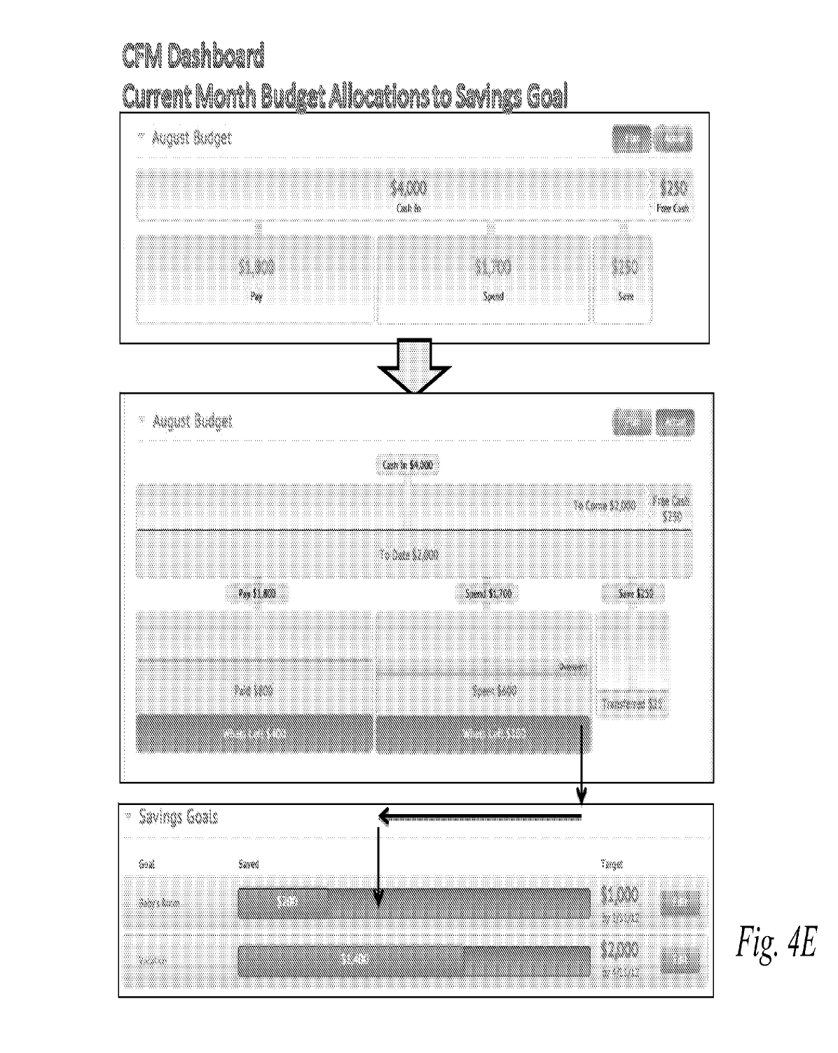

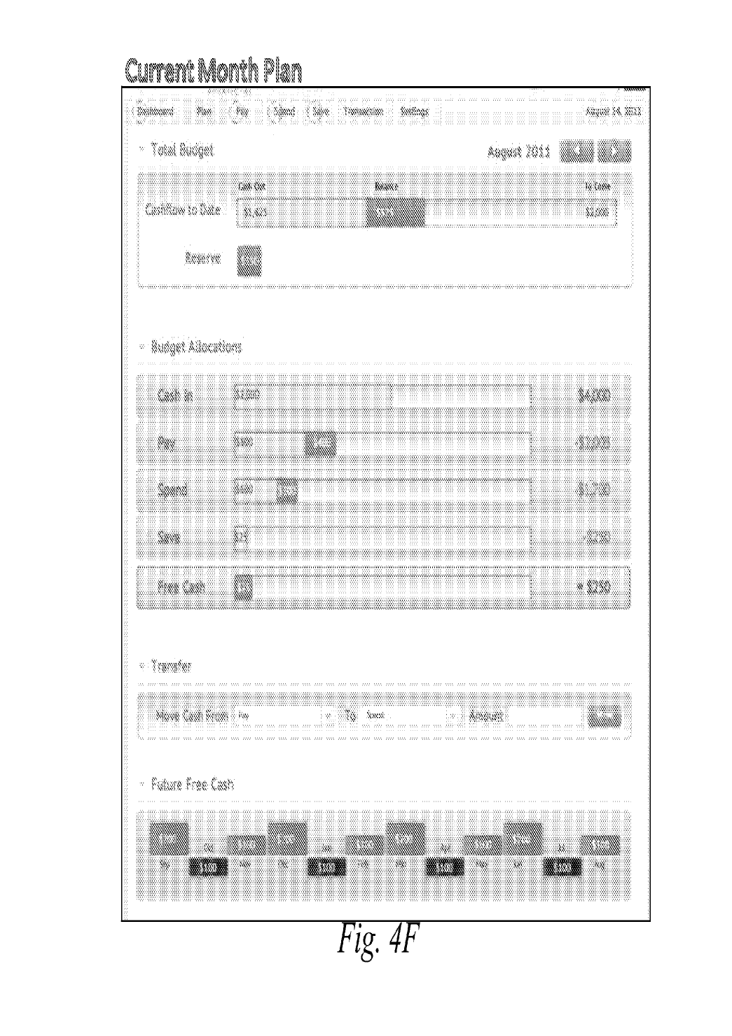

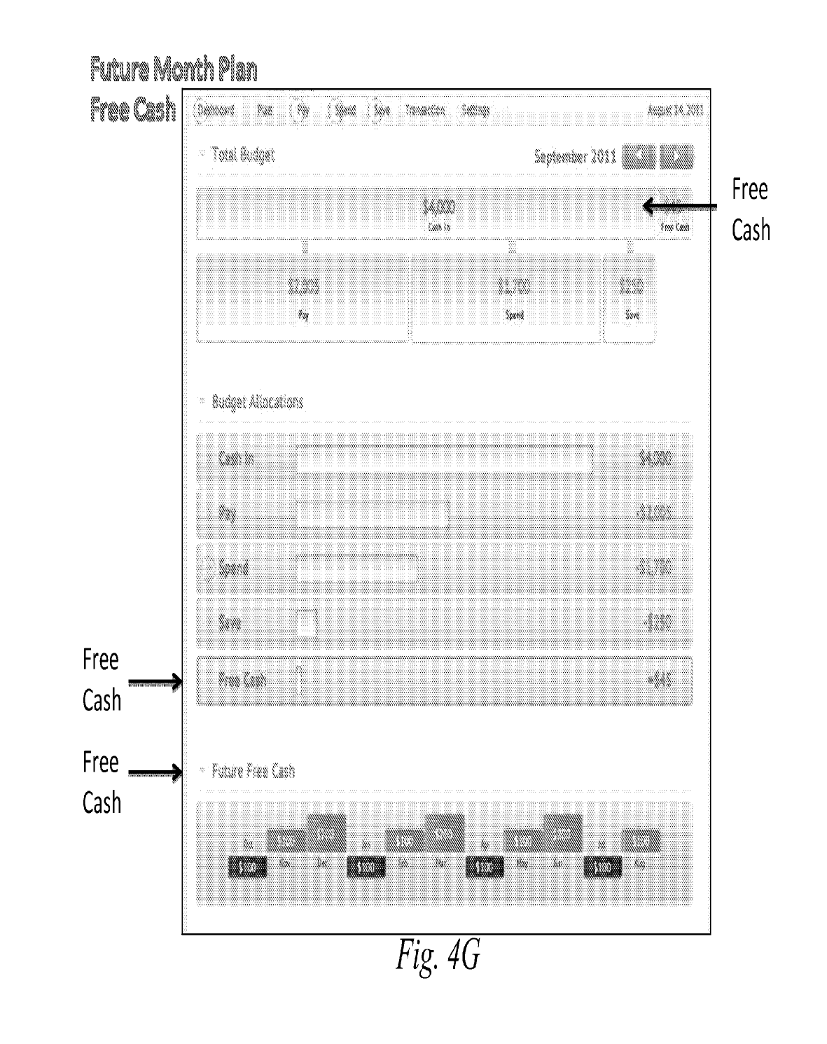

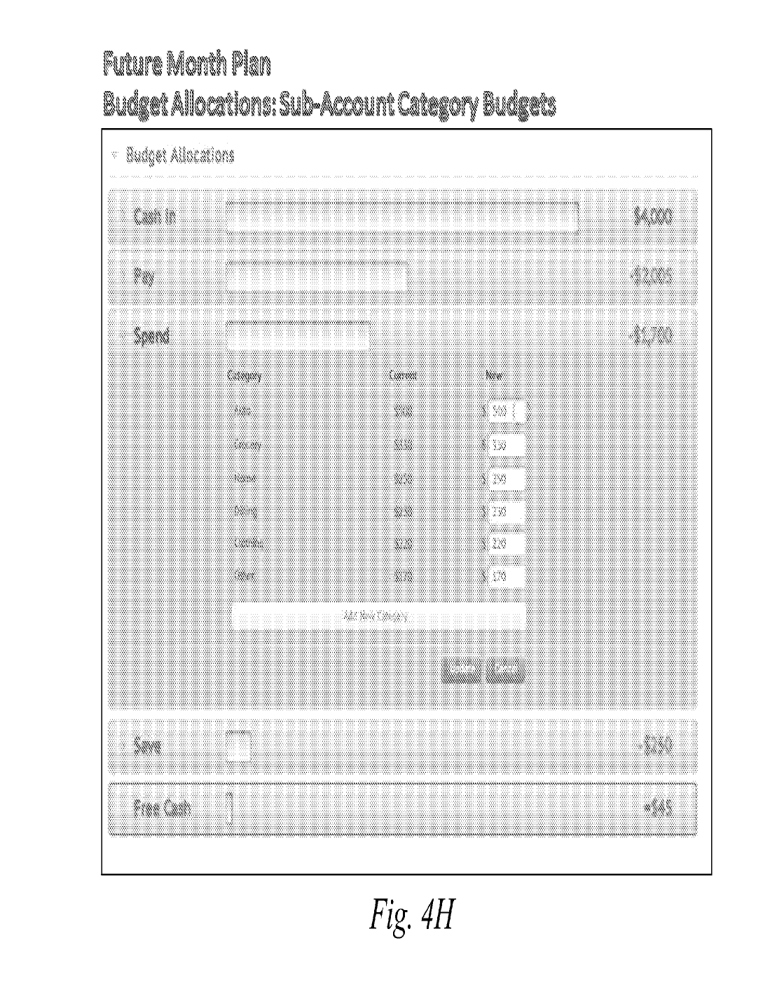

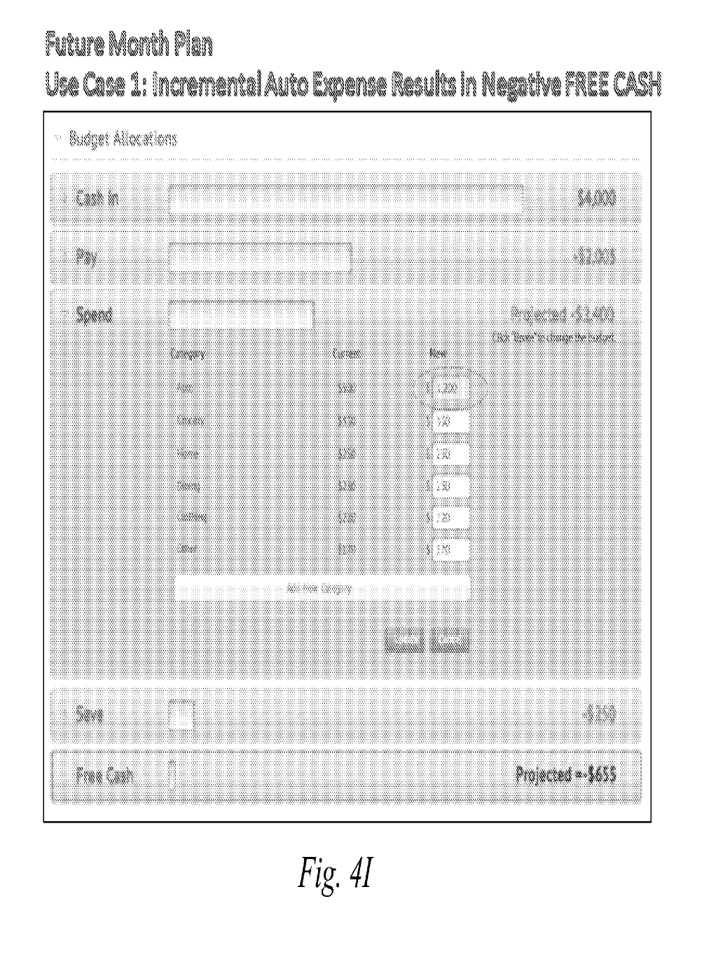

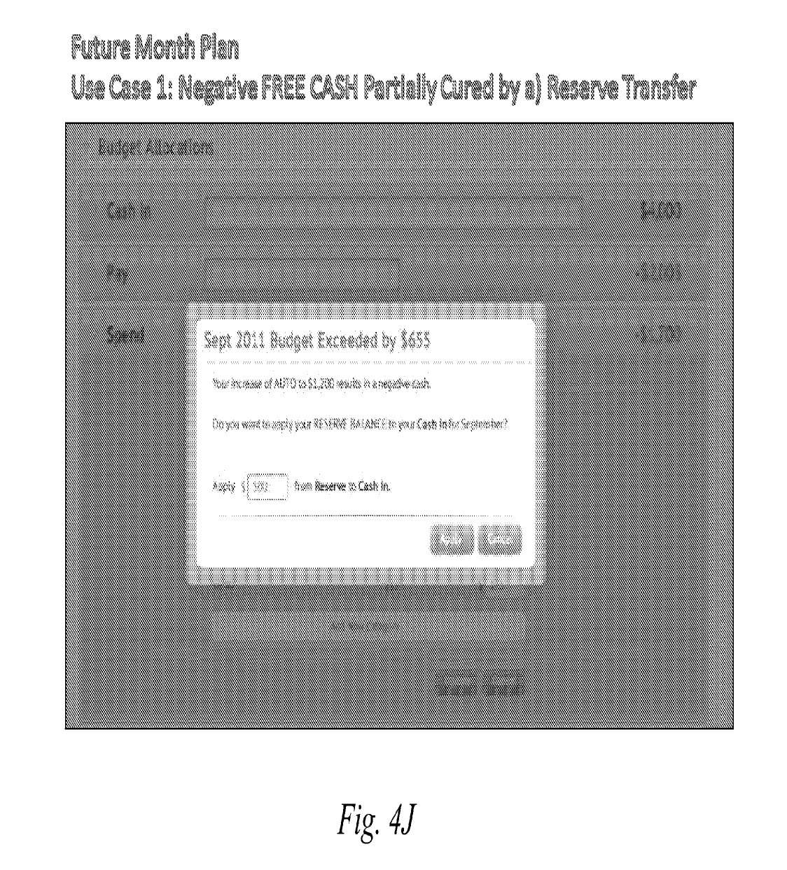

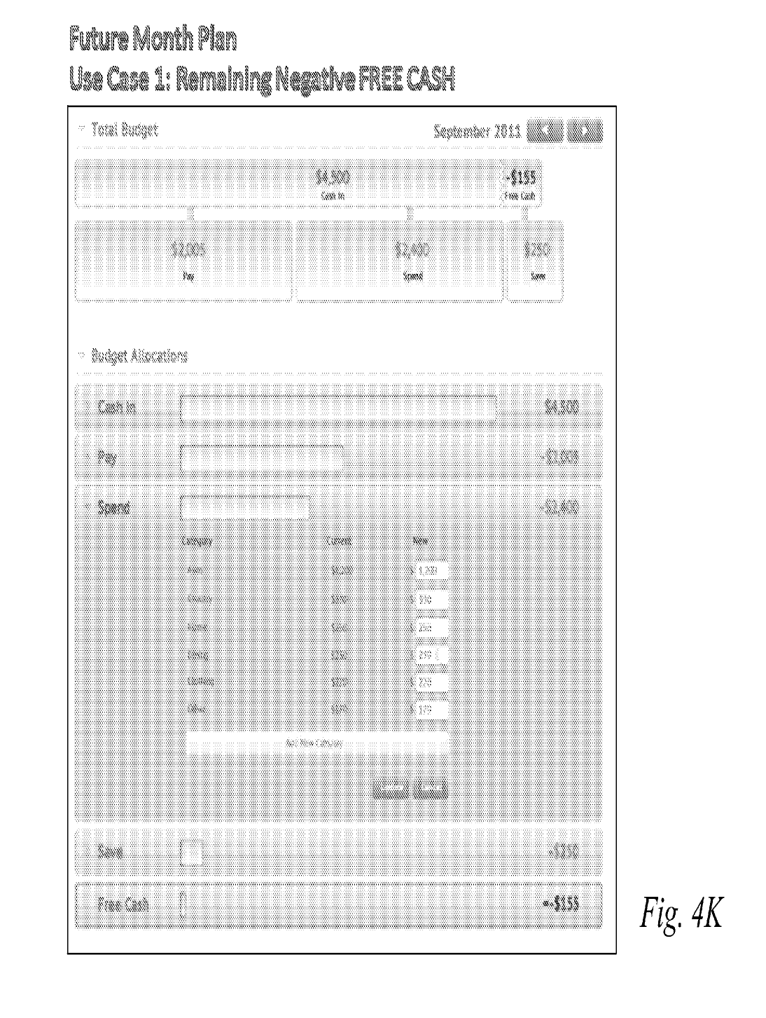

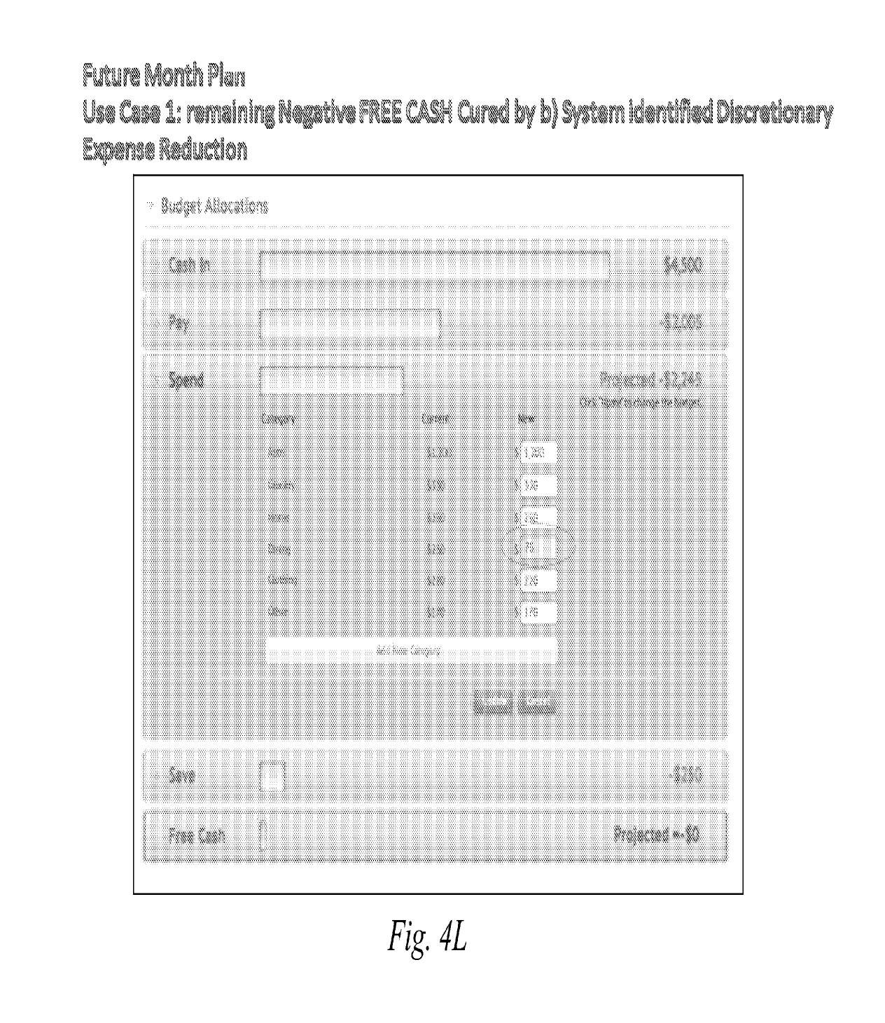

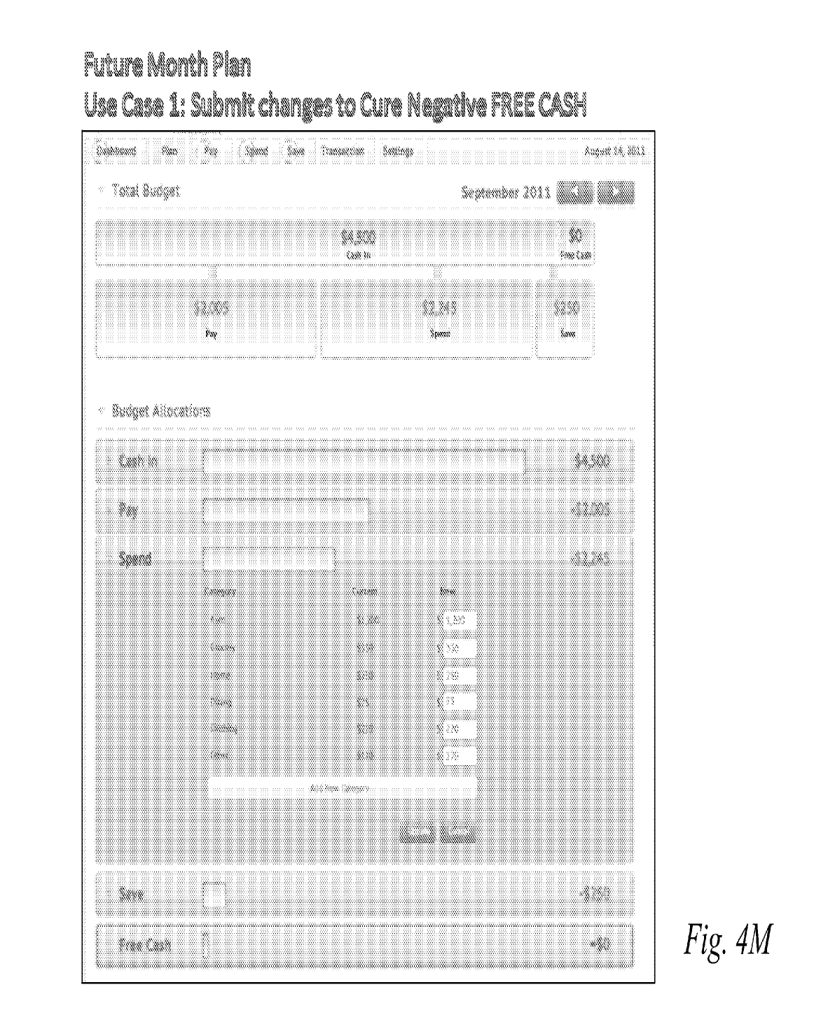

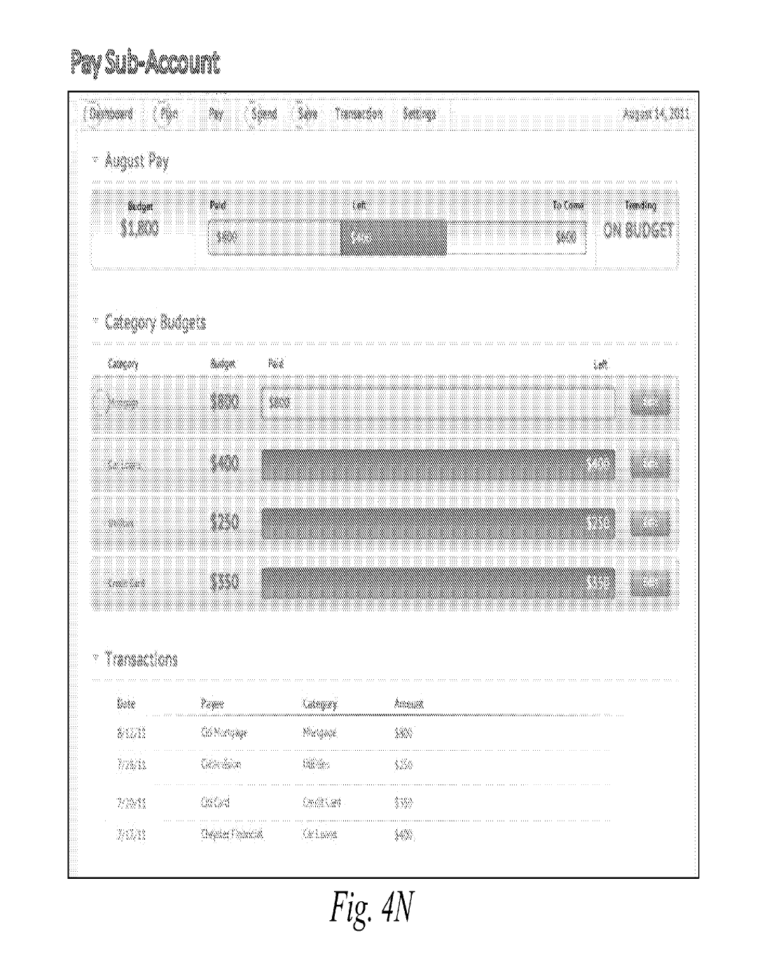

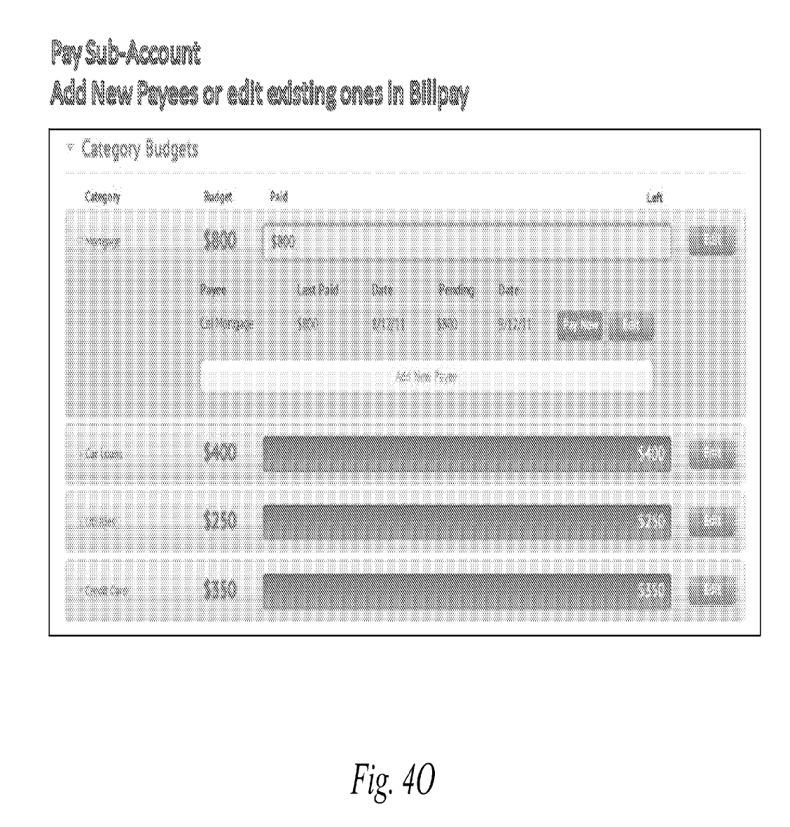

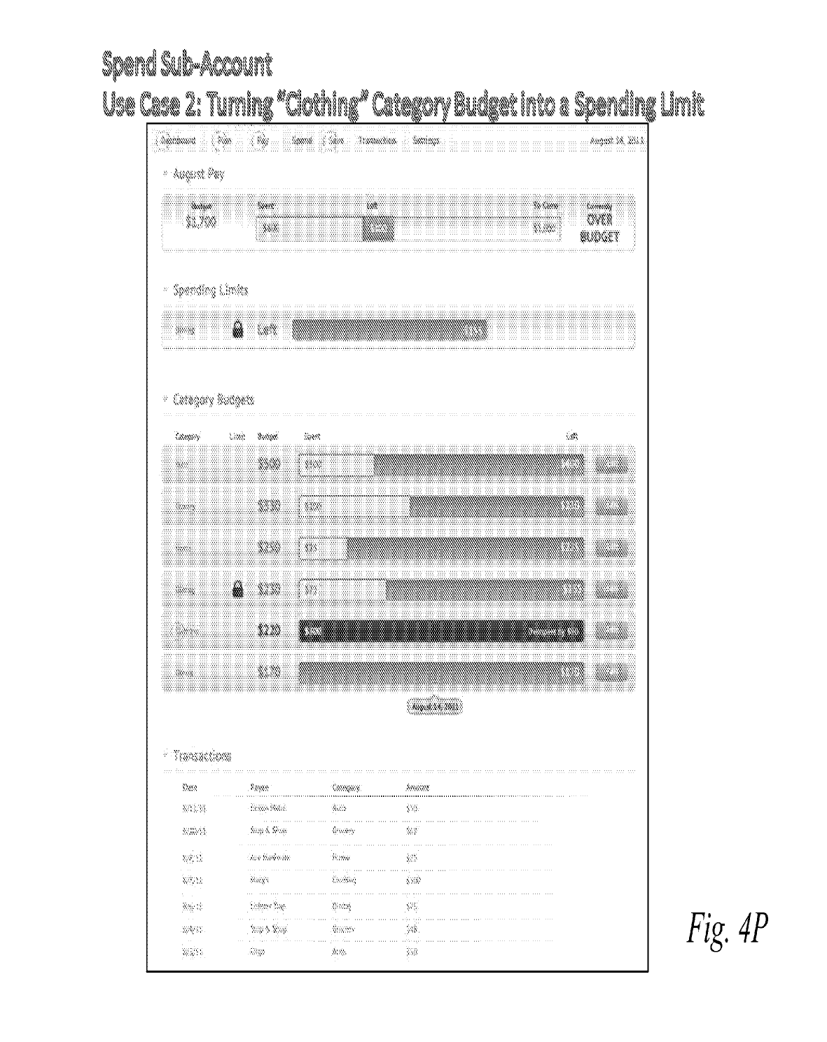

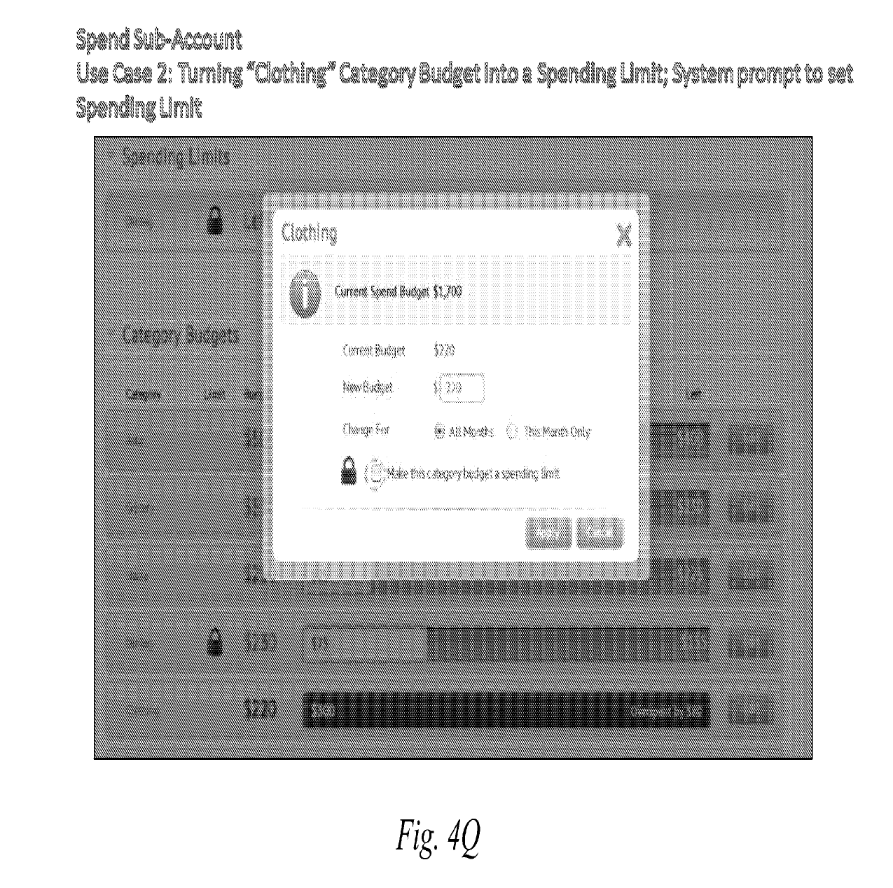

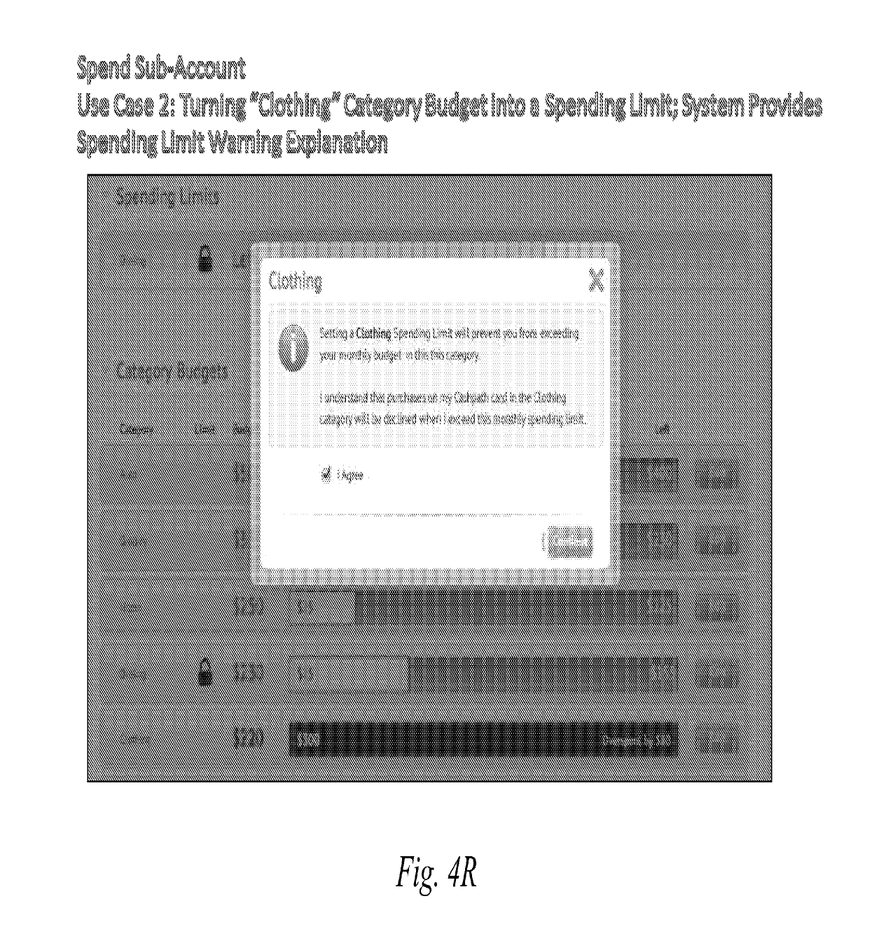

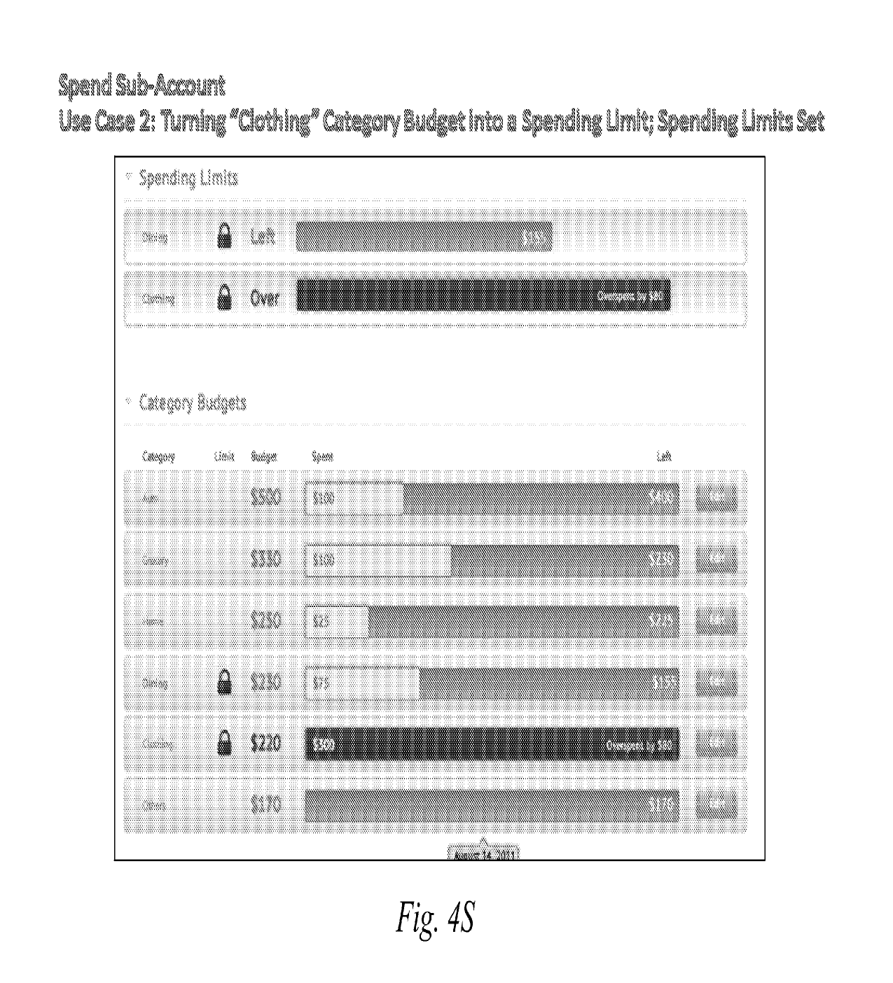

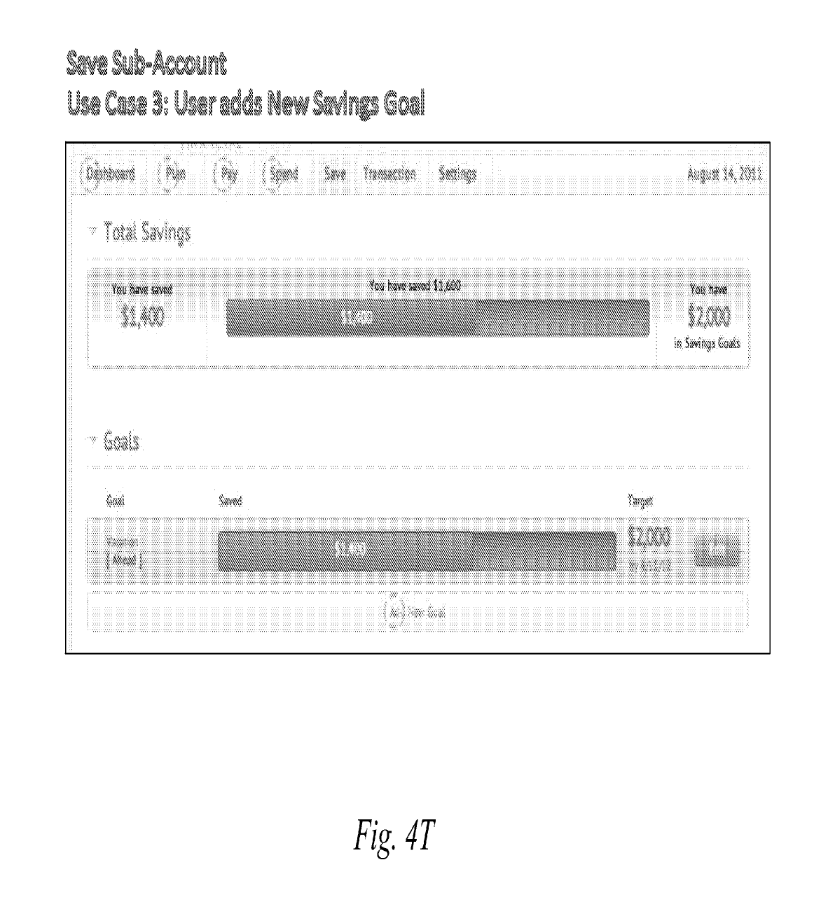

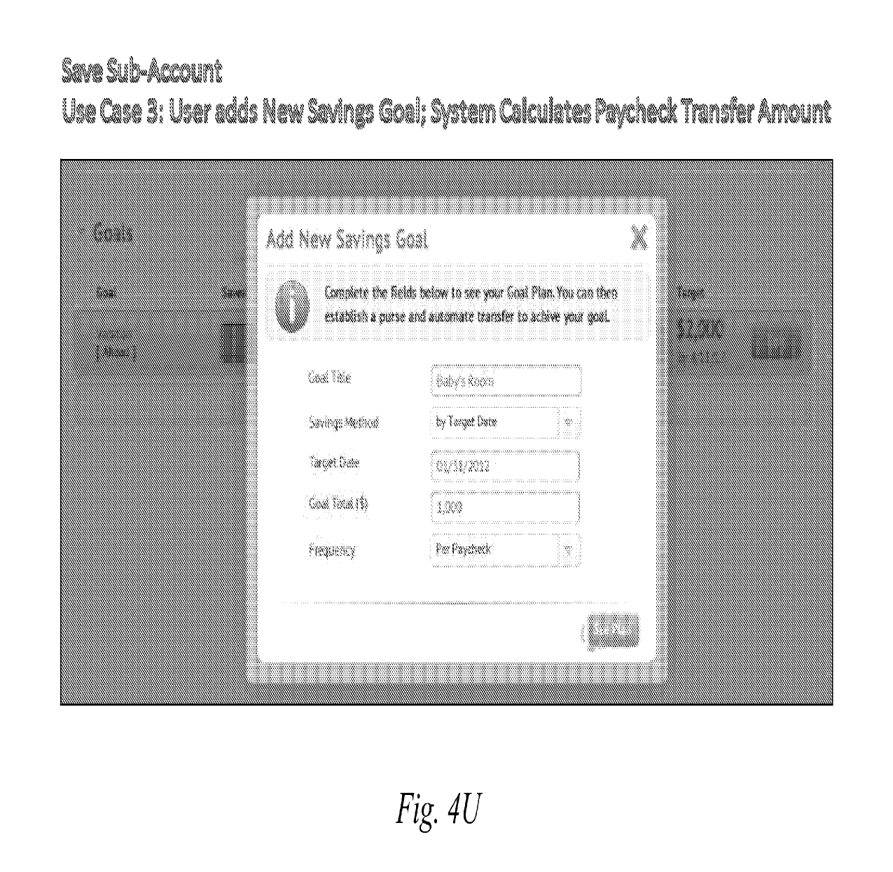

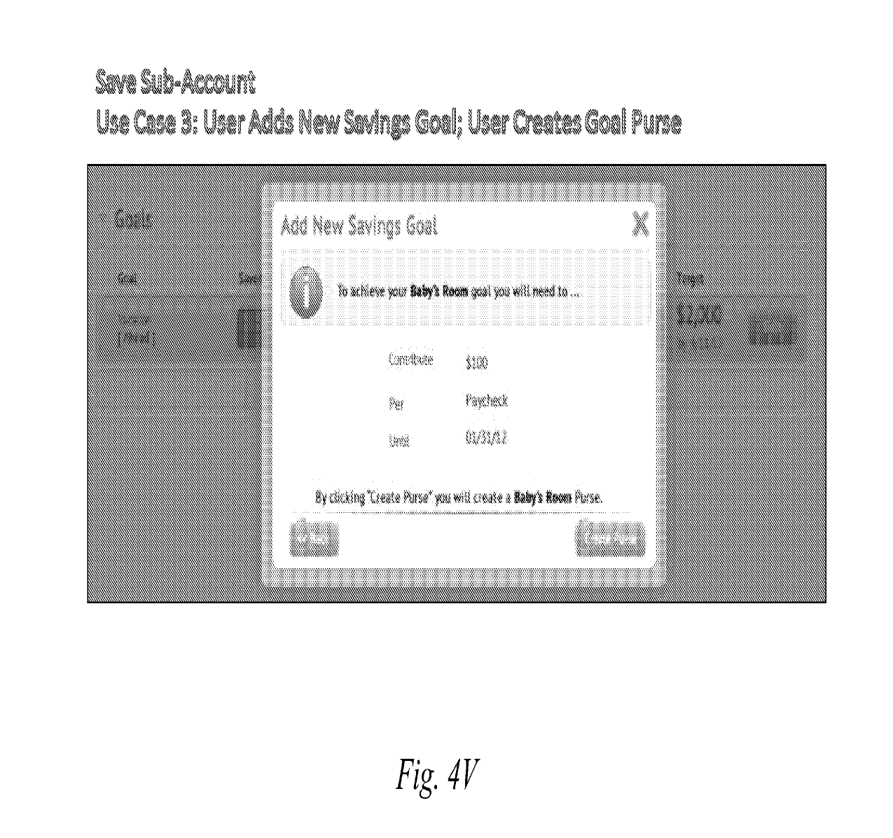

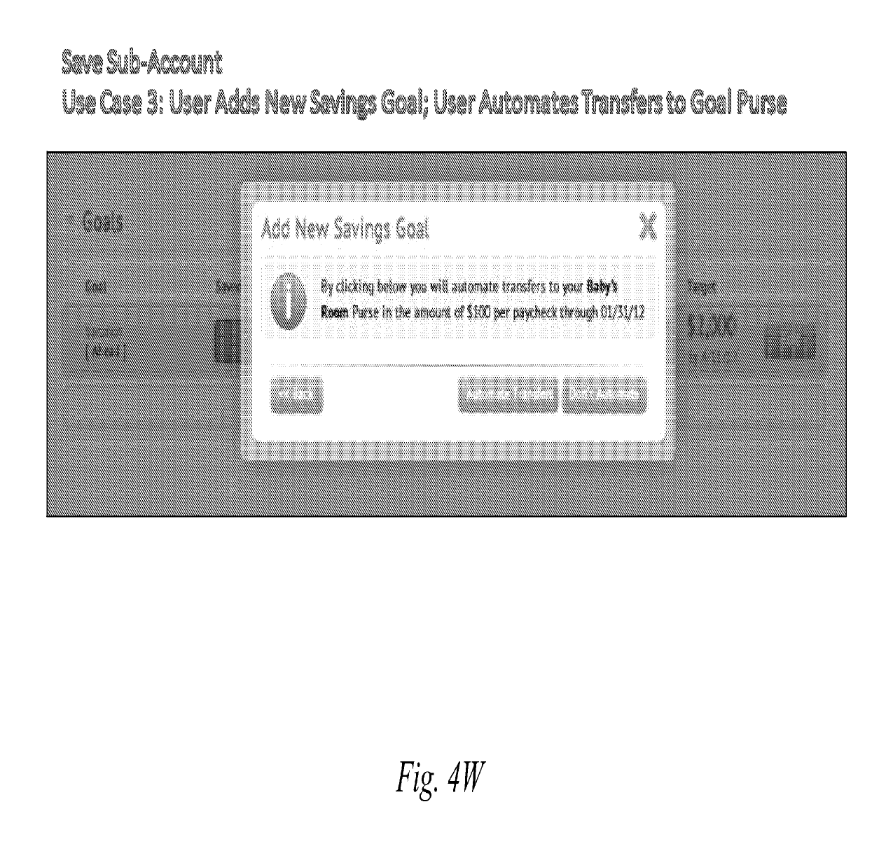

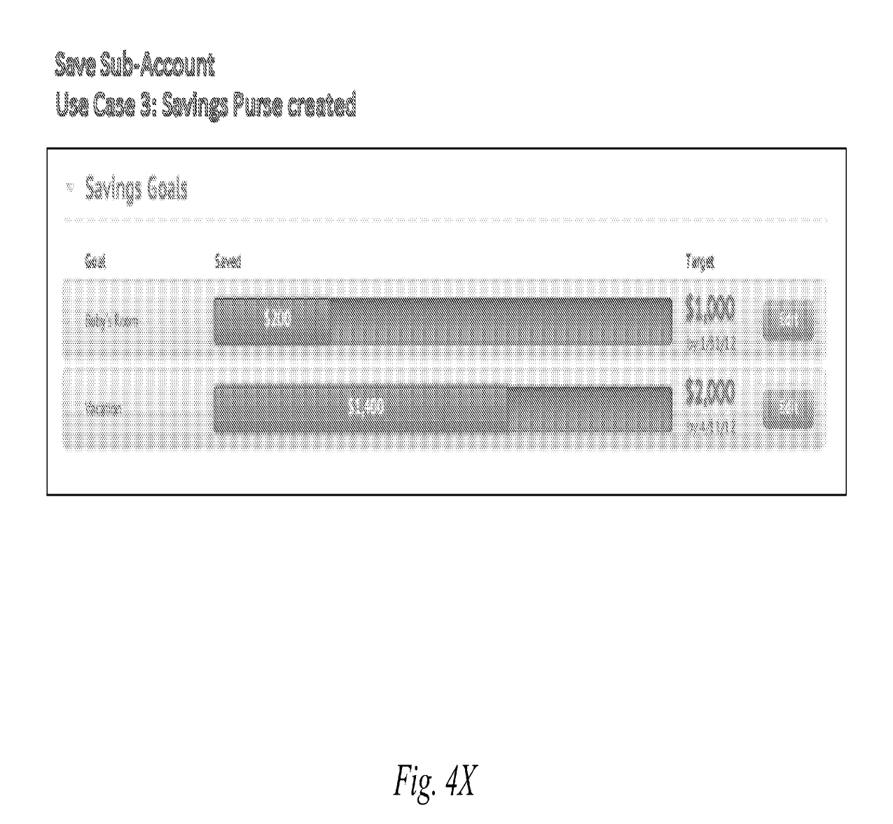

Referring now to FIGS. 4A-4X are various embodiments of user interface illustrating functionality of the CFM.

FIG. 4A illustrates another embodiment of setting up a CFM account. Via the user interface, a user may specify the frequency and amount of income to be deposited into the CFM account. The CFM account may receive income via direct deposit, which the user may specified via the user interface.

FIG. 4B illustrates an embodiment of a CFM dashboard. The dashboard displays the cash summary, the future balance, budget, savings goals and spending limits. The dashboard identifies the free cash positions on each day of the week.

FIG. 4C illustrates an embodiment of a CFM account dashboard showing current monthly budget allocations.

FIG. 4D illustrates an embodiment of a CFM account dashboard showing current monthly budget allocations with actual cash flows.

FIG. 4E illustrates an embodiment of a CFM account dashboard showing current monthly budget allocations to savings goals.

FIG. 4F illustrates an embodiment of a current month plan of the CFM.

FIG. 4G illustrates an embodiment of a future month plan with free cash.

FIG. 4H illustrates an embodiment of budget allocations of sub account category budgets for a future month plan.

FIG. 4I illustrates an embodiment of incremental auto expense resulting in negative cash flow for a future month plan.

FIG. 4J illustrates an embodiment of a negative free cash being cured, partially, by a reserve transfer.

FIG. 4K illustrates an embodiment of the CFM user interface displaying remaining negative free cash.

FIG. 4L illustrates an embodiment of the cash flow optimizer determining automatically a cure of a negative free cash via reduction to one or more discretionary expenses.

FIG. 4M illustrates an embodiment of submitting via the CFM the cure to negative free cash.

FIG. 4N illustrates an embodiment of the CFM displaying details and status of the pay sub-account.

FIG. 4O illustrates an embodiment of adding or editing payees for the pay sub-account.

FIG. 4P illustrates an embodiment of turning a category budget into a spending limit within the Spend sub-account

FIG. 4Q illustrates another embodiment of turning a category budget into a spending limit with CFM prompt to set limit.

FIG. 4R illustrates another embodiment of turning a category budget into a spending limit with CFM provided spending limit explanation.

FIG. 4S illustrates an embodiment of turning a category budget into a spending limit with spending limits set.

FIG. 4T illustrates an embodiment of adding a new saving goal via the CFM.

FIG. 4U illustrates an embodiment of CFM determining paycheck transfer amount for new saving goal.

FIG. 4V illustrates an embodiment of a user creating a goal purse via the CFM.

FIG. 4W illustrates an embodiment of automating transfers to goal purse for new savings goal.

FIG. 4X illustrates an embodiment of a created savings purse.

In view of the systems and methods described herein, any of the embodiments may be implemented, facilitated, supported or executed via any type and form of mobile application, such as a CFM based application executing on a smartphone and designed and constructed to implement functionality of the CFM and/or otherwise interact with the CFM system. Via a mobile device, a user may access the CFM via a user interface adapted and constructed for the mobile device. Via the mobile device, the user may access, view and interact with the CFM to establish or modify the cash flow management plan and any portions thereof and view usage against the cash flow management plan, including any cash forecast.

The user may use any type and form of mobile payment system and processor that is integrated with, interface to or in communication with the CFM. For example, via a CFM mobile based application, a user of a household may make mobile payments using any of the following models: Premium SMS based transactional payment, Direct Mobile Billing, Mobile web payments (WAP) and Contactless NFC (Near Field Communication). Via the mobile device and mobile payment processor, the CFM may enforce spending and purchases at the point of sale when the mobile payment is to be applied and in accordance with the cash flow management plan. The mobile payment account may act as the prepaid card described above in connection with enforcing the spending plan. For the example, the CFM application on the mobile device may interface to the mobile payment application on the mobile device and/or the mobile payment processor to obtain purchase information and communicate with the CFM server application to obtain authorization and/or check against the cash flow management plan.

In view of the systems and methods described herein, the CFM system may provide any type and form of loans based on the cash flow management system. The CFM system may determine the credit worthiness or the amount of credit to extend to a user or household based on free cash availability or any metrics of free cash, such as average free cash amounts on a daily, weekly or monthly basis. The CFM may automatically build into or modify the user's or household's cash flow management plan to account for the loan payment based on the terms of the loan. For example, the CFM may configure or change the pay sub-account to pay the loan. The CFM may provide revolving credit or changing credit line based on execution of the cash flow management plan in view of free cash availability and/or paying down the credit via the pay sub-account. The CFM may determine and offer any financial products to a household based on the cash flow management plan, execution of the same and any metrics and data tracked by the CFM.

While the invention has been particularly shown and described with reference to specific embodiments, it should be understood by those skilled in the art that various changes in form and detail may be made therein without departing from the spirit and scope of the invention described in this disclosure.

What is claimed:

1. A method for automatically managing cash flow of a household, the method comprising:
(a) identifying, by a cash flow manager executing on one or more servers, receipt of an amount of income from one or more sources of income of a household into a household account, the household account comprising a pay sub-account, a spend sub-account and a save sub-account;
(b) allocating automatically, by the cash flow manager responsive to the receipt of the amount of income, amounts from the amount of income into each of the pay sub-account, the spend sub-account and the save sub-account of the household account in accordance with a cash flow management plan of the household stored in association with the household account maintained by the cash flow manager; and
(c) tracking, by the cash flow manager, use of cash by the household across each of the pay sub-account, the spend sub-account and the save sub-account against a corresponding sub-account budget plan of the cash flow management plan for the household account.

2. The method of claim 1, wherein step (a) further comprises receiving, by a user interface of the cash flow manager from a user of the household account, information to establish in the cash flow management plan a spending budget plan for the spend sub-account, a pay plan for the pay sub-account and a savings plan for the save sub-account.

3. The method of claim 1, wherein step (a) further comprises identifying, by the cash flow manager, receipt of a monthly electronic deposit into the household account of a predetermined amount of income.

4. The method of claim 1, wherein step (b) further comprises automatically executing, by the cash flow manager, a transaction to fund a financial card of a user of the household with a spending amount in accordance with a spending budget plan and based on the allocation of an amount from the amount of income to the spend sub-account.

5. The method of claim 4, wherein step (c) further comprises enforcing, by the cash flow manager, spending via the financial card in accordance with the spending budget plan by only authorizing one or more vendors to deduct funds from the financial card based on whether the vendors sells items falling with one or more predetermined categories of the spending budget plan.

6. The method of claim 1, wherein step (b) further comprises automatically executing, by the cash flow manager, one or more transactions to electronically pay bills of the household in accordance with a pay budget plan and based on the allocation of an amount from the amount of income to the pay sub-account.

7. The method of claim 1, wherein step (b) further comprises automatically executing, by the cash flow manager, one or more transactions with one or more payment processors to electronically pay bills of the household in accordance with a pay budget plan and based on the allocation of an amount from the amount of income to the pay sub-account.

8. The method of claim 1, wherein step (b) further comprises automatically applying, by the cash flow manager, predetermined amounts of funds allocated to the save sub-account to one or more goals in accordance with a save budget plan and based on the allocation of an amount from the amount of income to the save sub-account.

9. The method of claim 1, wherein step (b) further comprises automatically identifying, by the cash flow manager, any funds in the household account that are remaining after amounts from the amount of income have been allocated to each of the pay sub-account, spend sub-account and save sub-account in accordance with the respective sub-account budget plans.

10. The method of claim 1, wherein step (c) further comprises generating, by the cash flow manager, a cash flow forecast based on budgeted and actual use of cash by the household across each of the pay sub-account, the spend sub-account and the save sub-account.

11. A system for automatically managing cash flow of a household, the system comprising:
a cash flow manager executing on one or more servers;
a household account maintained by the cash flow manager, the household account comprising a pay sub-account, a spend sub-account and a save sub-account of a household;
a cash flow management plan of the household configured via the cash flow manager and stored in association with the household account;
wherein the cash flow manager identifies receipt of an amount of income from one or more sources of income of a household into the household account and responsive to the receipt of the amount of income automatically allocates amounts from the amount of income into each of the pay sub-account, the spend sub-account and the save sub-account of the household account in accordance with the cash flow management plan; and
wherein the cash flow manager tracks use of cash by the household across each of the pay sub-account, the spend sub-account and the save sub-account against a corresponding sub-account budget plan of the cash flow management plan for the household account.

12. The system of claim 11, wherein a user interface of the cash flow manager receives from a user of the household account information to establish in the cash flow management plan a spending budget plan for the spend sub-account, a pay plan for the pay sub-account and a savings plan for the save sub-account.

13. The system of claim 11, wherein the cash flow manager identifies receipt of a monthly electronic deposit into the household account of a predetermined amount of income.

14. The system of claim 11, wherein the cash flow manager automatically executes a transaction to fund a financial card of a user of the household with a spending amount in accordance with a spending budget plan and based on the allocation of an amount from the amount of income to the spend sub-account.

15. The system of claim 14, wherein cash flow manager enforces spending via the financial card in accordance with the spending budget plan by only authorizing one or more vendors to deduct funds from the financial card based on whether the vendors sells items falling with one or more predetermined categories of the spending budget plan.

16. The system of claim 11, wherein the cash flow manager automatically executes one or more transactions to electronically pay bills of the household in accordance with a pay budget plan and based on the allocation of an amount from the amount of income to the pay sub-account.

17. The system of claim 11, wherein the cash flow manager automatically executes one or more transactions with one or more payment processors to electronically pay bills of the household in accordance with a pay budget plan and based on the allocation of an amount from the amount of income to the pay sub-account.

18. The system of claim 11, wherein the cash flow manager automatically applies predetermined amounts of funds allocated to the save sub-account to one or more goals in accordance with a save budget plan and based on the allocation of an amount from the amount of income to the save sub-account.

19. The system of claim 11, wherein the cash flow manager automatically identifies any funds in the household account that are remaining after amounts from the amount of income have been allocated to each of the pay sub-account, spend sub-account and save sub-account in accordance with the respective sub-account budget plans.

20. The system of claim 11, wherein the cash flow manager generates a cash flow forecast based on budgeted and actual use of cash by the household across each of the pay sub-account, the spend sub-account and the save sub-account.
